(19) United States
(12) Patent Application Publication
(10) Pub. No.: US 2025/0140459 A1
(43) Pub. Date: May 1, 2025

(54) SOFT MAGNETIC POWDER, MAGNETIC CORE, AND MAGNETIC DEVICE

(71) Applicant: TDK CORPORATION, Tokyo (JP)

(72) Inventors: Kensuke ARA, Tokyo (JP); Kazuhiro Yoshidome, Tokyo (JP)

(73) Assignee: TDK CORPORATION, Tokyo (JP)

(21) Appl. No.: 18/931,356

(22) Filed: Oct. 30, 2024

(30) Foreign Application Priority Data
Oct. 30, 2023 (JP) 2023-185856
Aug. 29, 2024 (JP) 2024-147931

(51) Int. Cl. H01F 1/20; C22C 38/02; C22C 38/10; C22C 38/30; H01F 27/255

(52) U.S. Cl. CPC H01F 1/20; C22C 38/02; C22C 38/10; C22C 38/30; C22C 2202/02; H01F 27/255

(57) ABSTRACT

A soft magnetic powder including a soft magnetic particle containing at least one selected from the group consisting of iron and cobalt: when the soft magnetic particle satisfies the relation of σ_{FeCo}(S)−σ_{FeCo}(C)≤−0.005, when an element distribution is divided into multiple grids to calculate a sum of content ratios of iron and cobalt in each grid, and a standard deviation of the sum of the content ratios is represented by σ_{FeCo}(S) where a population is the grids, and an element distribution is divided into multiple grids to calculate a sum of content ratios of iron and cobalt in each grid, and a standard deviation of the sum of the content ratios is represented by σ_{FeCo}(C) where a population is the multiple grids.

### TECHNICAL FIELD

The present disclosure relates to a soft magnetic powder, a soft magnetic core, and a magnetic device.

### BACKGROUND

Recently, in order to achieve a low-carbon society through energy conservation in response to global warming issues, there is a demand for improving power supply efficiency through a low loss of magnetic devices. Examples of a means to achieve the low loss of the magnetic devices include a method of reducing a copper loss by reducing the number of turns of coil by using a magnetic core with a high permeability, and a method of forming a magnetic core using a magnetic material with a small iron loss (core loss).

Patent Document 1 discloses a method of forming a magnetic material with a low loss by placing insulation materials between magnetic particles of Fe—Si alloy powder. This method allows to reduce eddy current, however, a reduction of hysteresis loss is not considered, thus this method is not sufficient as a means to obtain a magnetic core with a high permeability.
[Patent Document 1] JP Patent Laid Open No. 2002-33211

### SUMMARY

The present disclosure is achieved in view of such circumstances, and the object is to provide a magnetic core and a magnetic device with a high permeability and a low loss, and also to provide a soft magnetic powder suitable for the production of such magnetic core and magnetic device.

Embodiments of the present disclosure are described as in below.

[1] A soft magnetic powder including a soft magnetic particle containing at least one selected from the group consisting of iron and cobalt:
provided that the soft magnetic particle satisfies the relation of σ_{FeCo}(S)−σ_{FeCo}(C)≤−0.005, when an element distribution obtained by analyzing a surface part of the soft magnetic particle using a 3D atom probe method is divided into a plurality of grids to calculate a sum of a content ratio of iron and a content ratio of cobalt in each grid, and a standard deviation of the sum of the content ratio of iron and the content ratio of cobalt is represented by σ_{FeCo}(S) where a population is the plurality of grids, and
an element distribution obtained by analyzing a center part of the soft magnetic particle using a 3D atom probe method is divided into a plurality of grids to calculate a sum of a content ratio of iron and a content ratio of cobalt in each grid, and a standard deviation of the sum of the content ratio of iron and the content ratio of cobalt is represented by σ_{FeCo}(C) where a population is the plurality of grids.

[2] A magnetic core comprising the soft magnetic powder according to [1].

[3] A magnetic device comprising the magnetic core according to [2].

### BRIEF DESCRIPTION OF DRAWINGS

FIG. 1 is a schematic diagram of a cross section of a soft magnetic powder according to the present embodiment.

FIG. 2 is a schematic diagram which explains an area of a soft magnetic particle observed using 3DAP.

FIG. 3 is a schematic diagram of a cross section of a magnetic core according to the present embodiment.

FIG. 4A shows a result of observation by 3DAP regarding iron distribution in a sample according to the examples.

FIG. 4B is a result of observation by 3DAP regarding a cobalt distribution in a sample according to the examples.

### DETAILED DESCRIPTION

### (1. Soft Magnetic Powder)

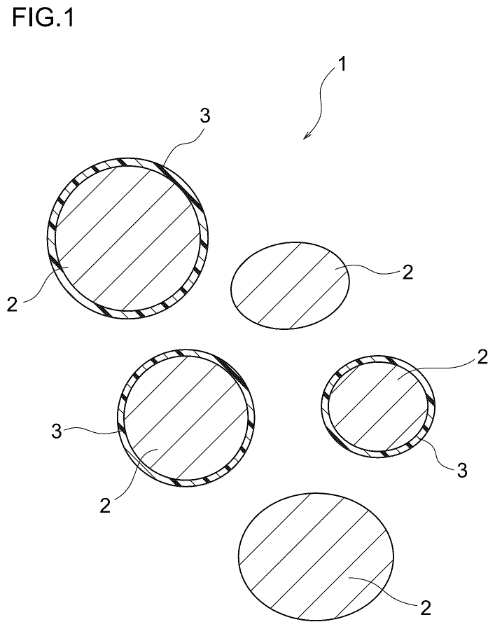

A soft magnetic powder 1 according to the present embodiment includes soft magnetic particles 2, as shown in FIG. 1. In the soft magnetic powder 1, a position of each soft magnetic particle 2 is not fixed, thus the soft magnetic powder 1 has a fluidity.

An average particle size (D50) of the soft magnetic powder according to the present embodiment can be selected depending on the use or so. For example, the average particle size (D50) may be between 3 to 100 μm. The average particle size may be controlled by a powder production condition, may be controlled by a classification treatment, or so. In the present specification, the particle size of the soft magnetic particle is a particle size which is measured using a laser diffraction scattering method.

Also, examples of a shape of the soft magnetic particle include a spherical shape or a shape close to a spherical shape. For example, an average circularity of a cross section of the soft magnetic particle may be 0.7 or greater, preferably 0.85 or greater, or even more preferably 0.9 or greater. As a circularity, for example, Wadell's circularity can be used.

As long as the below described relation is satisfied, the soft magnetic powder may include the soft magnetic particles made of same material, or may include the soft magnetic particles made of different materials being mixed. Note that, examples of “the different materials” include the case in which elements constituting the soft magnetic metals are different, or the case in which the elements constituting the soft magnetic metals are the same but the composition are different.

In the present embodiment, a surface of the soft magnetic particle may be at least partially covered with a coating part having an insulation property. As the coating part having an insulation property, for example, it may be an oxide coating formed by oxidizing the surface of the soft magnetic particle, or the coating part may be formed on the surface of the soft magnetic particle using an insulation material. As the insulation material, preferably inorganic materials such as oxides, nitrides, carbides, etc., may be used. Examples of oxides include SiO₂, MgO, Al₂O₃, phosphates, silicates, borosilicates, and bismuthates; and these may be a crystalline or a glass. Examples of the oxide glass include a phosphate-based glass, a bismuthate-based glass, a borosilicate-based glass, etc. The coating part may be configured of a plurality of coating parts. For example, the coating part may be formed using an insulation material on the oxide coating which is formed by oxidizing the surface of the soft magnetic particle.

An average thickness of the coating part is preferably between 1 nm or more and 250 nm or less, or more preferably between 20 nm or more and 250 nm or less.

The soft magnetic powder according to the present embodiment may only include the soft magnetic particles to which the coating parts are not formed; may include the soft magnetic particles to which the coating parts are not formed and also the soft magnetic particles to which the coating parts are formed; or may only include the soft magnetic particles to which the coating parts are formed.

In the present embodiment, the soft magnetic particle is configured of soft magnetic metals including at least one element selected from the group consisting of iron (Fe) and cobalt (Co). That is, the soft magnetic particle may be configured of the soft magnetic metal including iron; may be configured of the soft magnetic metal including cobalt; or may be configured of soft magnetic metal including cobalt and iron. In the present embodiment, the soft magnetic metal is preferably the soft magnetic metal including iron, or preferably a soft magnetic metal including iron and cobalt.

The soft magnetic metals including at least one element selected from the group consisting of iron and cobalt may have a crystalline structure, may have an amorphous structure, or may have a nanocrystal structure.

The soft magnetic metals including at least one element selected from the group consisting of iron and cobalt can include other elements in addition to iron and cobalt. Said soft magnetic metals may include an element X, may include chromium (Cr), may include nickel (Ni), or may include an element M.

The element X is at least one element selected from the group consisting of B (boron), Si (silicon), P (phosphorus) and C (carbon). By including the element X, a magnetocrystalline anisotropy can be reduced, therefore a coercivity can be reduced.

The element M is at least one element selected from the group consisting of Al (aluminum), S (sulfur), Ti (titanium), V (vanadium), Mn (manganese), Cu (copper), Zr (zirconium), Nb (niobium), Mo (molybdenum), Zn (zinc), Ga (gallium), As (arsenic), Ag (silver), Sn (tin), Sb (antimony), Au (gold), Bi (bismuth), Y (yttrium), La (lanthanum), Pt (platinum), Mg (magnesium), Ca (calcium), N (nitrogen), O (oxygen), Hf (hafnium), Ta (tantalum), and W (tungsten). By including the element M, a content of M is changed, thereby an amorphous structure and a nanocrystal structure can be controlled. Hence, a structure which can achieve good soft magnetic properties can be obtained.

In the present embodiment, when Cr is included, a powder with a high corrosion resistance can be obtained.

In the present embodiment, a composition of the soft magnetic metal including at least one element selected from the group consisting of iron and cobalt can be expressed by a compositional formula of (Fe_{1-α}Co_{α})_{100-w-x-y-z}Ni_{w}XₓCr_{y}M_{z} which is in terms of the number of atoms. In the above-mentioned compositional formula, “X” is the above-mentioned element X, and it is at least one element selected from the group consisting of B, Si, P, and C. Further, “M” is the above-mentioned element M, and it is at least one element selected from the group consisting of Al, S, Ti, V, Mn, Cu, Zr, Nb, Mo, Zn, Ga, As, Ag, Sn, Sb, Au, Bi, Y, La, Pt, Mg, Ca, N, O, Hf, Ta, and W.

In the above-mentioned compositional formula, “a”, “w”, “x”, “y”, and “z” preferably satisfy the relations of 0≤α≤1, 0≤w≤80, 3≤x≤30, 0≤y≤8, and 0≤z≤11.

Besides the above-mentioned elements, the above-mentioned soft magnetic metals may include elements as inevitable impurities. For example, a total content of said element other than the above-mentioned elements is preferably 0.1 mass % or less, or 0.05 mass % or less in 100 mass % of the above-mentioned soft magnetic metals.

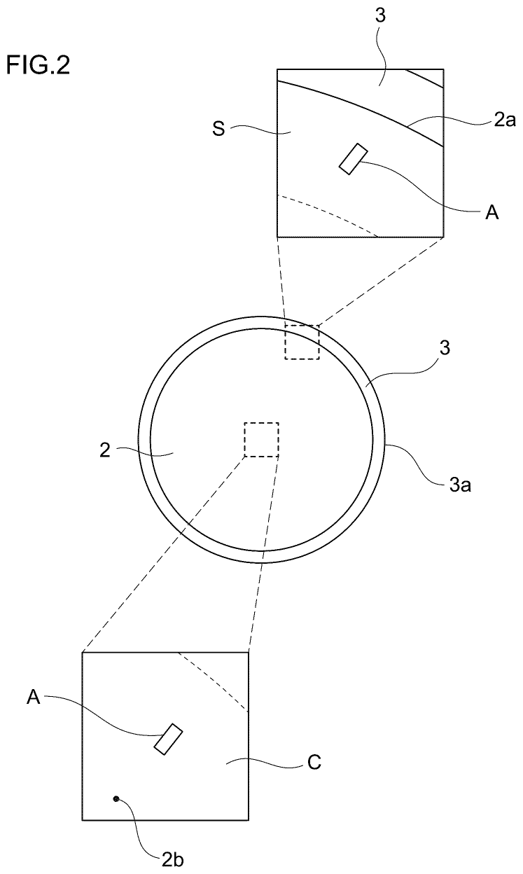

In the present embodiment, an element analysis is carried out using three-dimensional atom probe method to the surface part and the center part of the soft magnetic particle. As shown in FIG. 2, the surface part S is an area between the surface and the position at 500 nm from the surface in the direction towards the center of the soft magnetic particle 2. The surface of the soft magnetic particle is an outer most surface 2a which is an area where the composition of the above-mentioned soft magnetic metal is maintained in the particle. Therefore, in the case that the coating part 3 (including a naturally oxidized coating) is formed on the soft magnetic particle, an outer most surface 3a of such coating part 3 is not the surface of the soft magnetic particle, but the outer most surface 2a is the surface of the soft magnetic particle where the composition of the above-mentioned soft magnetic metal is maintained.

As shown in FIG. 2, a center part C is an area between the center and the position at 300 nm from the center in the direction towards the surface from a center 2b of the soft magnetic metal particle 2. In the case that the soft magnetic particle has a shape other than a spherical shape, a center of gravity of the soft magnetic particle is the center.

A three-dimensional atom probe (3DAP) method is a method in which high electric field is applied to a tip of a needle-shape sample, and atoms on the sample surface are ionized, then atoms are released from the sample, thereby the released ions are detected by a detector. The distribution of elements constituting the sample can be observed three-dimensionally based on a time of flight to the detector and the detected position.

As an observation area A of the element distribution shown in FIG. 2, it may be an area which can calculate a standard deviation of a total content ratio of iron and cobalt which is explained later. In the present embodiment, the observation area is 3200 nm³ or larger, or more preferably 20000 nm³ or larger. A shape of the observation area may be selected depending on the shape of a grid which is made by dividing the observation area. For example, the shape of the observation area is a rectangular-parallelepiped shape.

The observation area is divided into a plurality of grids. The shape of the grid is, for example, a cubic shape. A size of the grid can be set depending on the number of grids. The number of grids is the number of a population for calculating the standard deviation of the total content ratio of the iron and cobalt. Therefore, the number of grids is preferably set to a number which can accurately calculate the standard deviation. In the present embodiment, the number of grids is set to 400 or more.

Therefore, in the case that the observation area is a parallelepiped shape of 10 nm×10 nm×200 nm, the parallelepiped shape is divided into 2500 cubic shaped grids each having 2 nm×2 nm×2 nm.

Next, for each divided grid, a content ratio (concentration) of iron and a content ratio (concentration) of cobalt are calculated, and a sum of the content ratio of iron and the content ratio of cobalt in each grid is calculated. Regarding the soft magnetic metals as a whole, the composition is uniform, however, the sum of the content ratio of iron and the content ratio of cobalt in a localized microscopic area such as a grid may differ in each grid (it may exhibit variation per each grid). Such variation per each grid is represented as a standard deviation of a sum of the content ratio of iron and the content ratio of cobalt. That is, for example, a sum of the content ratio of iron and the content ratio of cobalt in the divided grids, such as 2500 grids, is used as a population, and the standard deviation of the sum of the content ratio of iron and the content ratio of cobalt is calculated.

In the present embodiment, when the standard deviation of the sum of the content ratio of iron and the content ratio of cobalt in the surface part of the soft magnetic particle is represented by σ_{FeCo}(S), and the standard deviation of the sum of the content ratio of iron and the content ratio of cobalt in the center part of soft magnetic particle is represented by σ_{FeCo}(C), then σ_{FeCo}(S) and σ_{FeCo}(C) satisfy the relation of σ_{FeCo}(S)−σ_{FeCo}(C)≤−0.005. That is, this shows that a variation of the sum of the content ratio of iron and the content ratio of cobalt in the center part is larger than a variation of the sum of the content ratio of iron and the content ratio of cobalt in the surface part.

When the variation of the sum of the content ratio of iron and the content ratio of cobalt in the surface part is small, it is thought that this means the distance between the atoms of the constitutional elements near the surface of the soft magnetic particle is highly uniform, and that strain and stress near the surface of the soft magnetic particle are low. Such strain and stress cause the permeability to decrease, hence it is speculated that the soft magnetic particle satisfying the above-mentioned standard deviation has a high permeability near the surface.

Here, in the magnetic core configured by filling the soft magnetic powder, magnetic flux penetrates between the soft magnetic particles, thus it is speculated that the local permeability near the surface of the particle has a great influence on the permeability of the entire magnetic core. Therefore, by obtaining the magnetic core using the soft magnetic powder containing the soft magnetic particle which the standard deviation satisfies the above-mentioned relation, it is thought that the permeability improves.

Also, a hysteresis loss, which is one of the causes of a core loss, also influences uniformity of the material structure of the soft magnetic particle configuring the magnetic core. In the case that the material structure is not uniform, due to a local fluctuation of the permeability, a diamagnetic field is formed and a magnetic domain wall is trapped. Thus, the hysteresis loss increases. Particularly, the surface of the particle is a non-continuous surface, thus chances of causing the above-mentioned trap is a high.

However, the soft magnetic particle which the standard deviation satisfies the above-mentioned relation is highly uniform near the surface of the particle, and it is thought that the above-mentioned trap is suppressed from happening. As a result, the hysteresis loss is reduced, and the core loss of the magnetic core is thought to be lowered.

The upper limit of σ_{FeCo}(S)−σ_{FeCo}(C) may be −0.005, may be −0.01, or more preferably it may be −0.02. Further, the lower limit of σ_{FeCo}(S)−σ_{FeCo}(C), although it is not necessarily limited, may be −1.096 from the point of production method.

Regarding the measurement of σ_{FeCo}(S) and σ_{FeCo}(C), one position of one particle is measured, and the measured values can be used as σ_{FeCo}(S) and σ_{FeCo}(C) of the particle. The above-mentioned measurement is carried out to a plurality of soft magnetic particles. In the present embodiment, the number ratio of the soft magnetic particles in which σ_{FeCo}(S)−σ_{FeCo}(C) satisfies the above-mentioned relation is preferably 50% or more, or more preferably 65% or more when the number ratio of the plurality of soft magnetic particles which had been measured is considered as 100%.

### (2. Method of Producing Soft Magnetic Powder)

A method for producing the soft magnetic powder according to the present embodiment only needs to be a method which can produce the soft magnetic particle satisfying the above-mentioned relation of σ_{FeCo}. In the present embodiment, the soft magnetic powder is produced using a known method of production of the soft magnetic powder, and then a post-treatment is carried out to the produced soft magnetic powder.

Examples of the known method for producing a soft magnetic powder include a carbonyl method, a spray pyrolysis method, a CVD method, a PVD method, a gas atomization method, a water atomization method, a rotational disk method, etc. Further, a method of obtaining a powder by crushing a ribbon which is made using a single roll method may be mentioned as another example. In order to control the average particle size of the obtained powder, a classification process such as an air flow classification, a wet classification, a dry classification, etc., may be carried out. In the present embodiment, preferably, a gas atomization method, a water atomization method, etc., may be used.

As the post-treatment to the soft magnetic powder, a heat treatment (surface reducing treatment) is carried out in a predetermined reducing atmosphere. In the present embodiment, the predetermined reducing atmosphere is achieved using an inert atmospheric gas and a reducing atmospheric gas. By carrying out the heat treatment under such atmosphere, the soft magnetic particles satisfying the above-mentioned σ_{FeCo} can be produced easily. The soft magnetic particles satisfying the above-mentioned relation of σ_{FeCo} cannot be produced under atmosphere by only using inert atmospheric gas, and under atmosphere only using a reducing atmospheric gas.

Examples of the inert atmospheric gas include argon (Ar) gas, and helium (He) gas. Note that, nitrogen (N₂) gas is not preferable as the inert atmospheric gas. As the reducing atmospheric gas, hydrogen (H₂) gas and hydrocarbon gas are preferably used together. Examples of the hydrocarbon gas include methane (CH₄) gas, acetylene (C₂H₂) gas, and ethylene (C₂H₄) gas. Note that, the soft magnetic particle satisfying the above-mentioned relation of σ_{FeCo} cannot be produced under the atmosphere which uses the inert atmospheric gas and hydrogen gas together, and the atmosphere which uses the inert atmospheric gas and hydrocarbon gas.

In the atmospheric gas constituting the predetermined reducing atmosphere, hydrogen gas is preferably included by 1 to 5 vol %, hydrocarbon gas is preferably included by 1 to 8 vol %, and the rest is the inert atmospheric gas.

As the heat treatment condition, a heat treatment temperature may be 300° C. or higher, may be 500° C. or higher, or 800° C. or higher. The upper limit of the heat treatment temperature may be set depending on the composition, etc., of the soft magnetic metals. Also, a holding time at the heat treatment temperature may be between 1 minute and 2 hours. Also, this heat treatment may also function as a heat treatment for precipitating nanocrystals.

After the heat treatment under the predetermined reducing atmosphere, the soft magnetic powder according to the present embodiment is obtained.

### (3. Magnetic Core)

The magnetic core according to the present embodiment includes the above-mentioned soft magnetic powder, and also the magnetic core according to the present embodiment is formed to have a predetermined shape. In such magnetic core, the soft magnetic powder loses the fluidity which makes each of the soft magnetic particles included in the soft magnetic powder to be fixed at predetermined positions, and this is one of the configurational elements of the magnetic core. By including the above-mentioned soft magnetic powder in the magnetic core according to the present embodiment, a magnetic core with a high permeability and low loss can be obtained.

The magnetic core according to the present embodiment may include other powder in addition to the above-mentioned soft magnetic powder. That is, the magnetic core may only include the above-mentioned soft magnetic powder, or it may include a plurality of powders including the above-mentioned powder.

In the case that the magnetic core includes a plurality of types of soft magnetic powders, the composition of the particles included in each powder may be the same or may be different. Also, the average particle size of each powder may be the same or may be different. For example, the magnetic core may include two types of powders which are a large size powder having a large average particle size and a small size powder having a small average particle size; or the magnetic core may include three types of powders having different average particle sizes (that is, a large size powder, an intermediate size powder, and a small size powder). A mass ratio of the large size powder to the small size powder, or the mass ratio of the large size powder to an intermediate powder to the small size powder may be determined by taking into consideration of the obtained magnetic properties, etc. For example, the mass ratio of the large size powder to the small size powder may be 20 to 95 mass % of the large size powder and 5 to 80 mass % of the small size powder. Also, for example the mass ratio of the large size powder to the intermediate size powder to the small size powder may be 20 to 80 mass % of the intermediate size powder, and the rest may be divided by the large size powder and the small size powder in which the ratio between these two is not particularly limited, and for example, it may be 10 to 90%.

In the case that the magnetic core includes the plurality of types of the soft magnetic powders, the above-mentioned soft magnetic powder is preferably included as a powder with a relatively large average particle size (the large size powder and the intermediate size powder). Also, the above-mentioned soft magnetic powder is preferably included by 20 mass % or more, and more preferably included between 30 mass % or more and 100 mass % or less in 100 mass % of the powder included in the magnetic core.

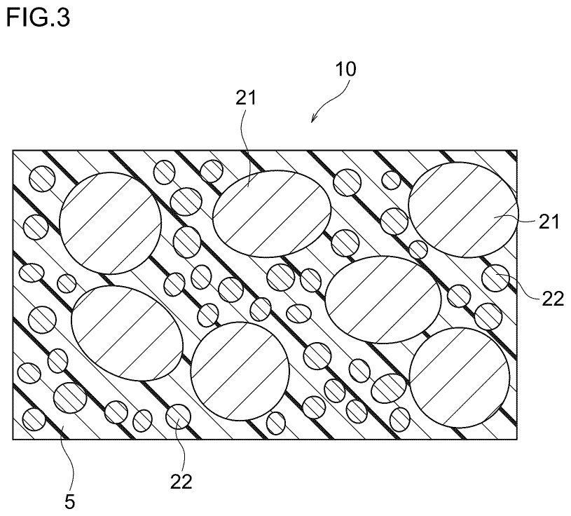

The magnetic core may include, in addition to the powder, a binder which binds the particles in the powder. Examples of the binder include heat curable resins such as an epoxy resin, a phenol resin, a silicone resin, etc. By including the resin, as shown in FIG. 3, the soft magnetic particles are bound with each other (the large size particle 21 of the large size powder and the small size particle 22 of the small size powder) via the resin 5 in the magnetic core 10, and the powder is fixed into a predetermined shape.

The ratio of the soft magnetic particles occupying the magnetic core (a filling rate) may be between 70 and 90%.

Any known method can be used for a method of producing the magnetic core. First, the binder (such as a heat curable resin) and a powder which at least includes the above-mentioned soft magnetic powder are mixed to obtain a mixture. Also, if needed, the obtained mixture may be formed into a granulated powder. A blending amount of the binder can be between 1 and 5 parts by mass with respect to 100 parts by mass of the powder.

Next, a mold is filled with the mixture or the granulated powder and compression molding is carried out, thereby a molded body having a shape of the magnetic core is obtained. The filling rate can be controlled by pressure of the compression molding.

For example, a curing treatment is carried out to the obtained molded body at a temperature between 50 and 200° C. to cure the resin and to fix the soft magnetic particles via the resin, thereby the magnetic core can be obtained.

### (4. Magnetic Device)

The magnetic device according to the present embodiment includes the above-mentioned magnetic core. The magnetic device may have a configuration that a coil is embedded in the magnetic core, or may have a configuration that a wire is wound around the surface of the magnetic core. Examples of such magnetic device include an inductor, a transformer, a choke coil, etc.

Hereinabove, the embodiment of the present disclosure has been described, however, the present disclosure is not limited thereto, and various modifications may be possible within the scope of the present disclosure.

### EXAMPLES

In below, the present disclosure is described in detail using the examples, however, the present disclosure is not limited thereto in anyway.

### Experiment 1

In Experiment 1, a large size powder configured of the above-mentioned soft magnetic powder and a small size powder configured of pure iron (Fe) powder were mixed to produce a mixed powder, and using this mixed powder, magnetic cores of Sample Nos. 1a to 9d were produced. An average particle size (D50) of the small size powder was 1 μm.

The soft magnetic powder (large size powder) was produced as described in below. First, raw material metals were weighed so to obtain a composition of (Fe_{0.75}Co_{0.25})₉₀Si₁₀ in terms of the ratio of the number of atoms, and the raw material metals were placed in a crucible arranged in an atomization device. Next, the inside of a chamber of the atomization device was vacuumed, and then the crucible was heated by high frequency induction using a work coil provided at outside of the crucible. Thereby, the raw material metals in the crucible were melted and mixed to obtain a molten having a temperature of 1500° C.

The obtained molten was supplied into the chamber as a linear continuous fluid through a nozzle provided at a bottom of the crucible. Water was sprayed to the supplied molten, and thereby the soft magnetic powder was obtained. An average particle size (D50) of the obtained soft magnetic powder was 20 μm. Also, according to an ICP analysis, it was confirmed that the composition of the soft magnetic powder matched the composition of the raw material metals.

The obtained soft magnetic powder was subject to a post-treatment described in below, except for Sample Nos. 1a to 1d. In Sample Nos. 2a to 9d, the obtained soft magnetic powders were placed in a heat treatment furnace to perform a heat treatment. A heat treatment atmosphere included 3 vol % of hydrogen gas, 4 vol % of methane gas, and the rest was argon gas. A heat treatment temperature during the heat treatment was as shown in Table 1, and a holding time was 1 hour.

Regarding Sample Nos. 1a to 9d, needle-like samples were made from surface parts and center parts of a plurality of particles of the collected soft magnetic powders, and the needle-like samples were observed using a 3DAP method to obtain an element distribution included in the particles. In the present example, the surface part of the particle is an area between the surface of the particle and the position at 50 to 250 nm from the surface in the direction towards the center of the particle. The center part of the particle is an area between the center and the position of +100 nm towards the surface of the particle. Note that, “the surface of the particle” does not include an oxide coating formed on the surface.

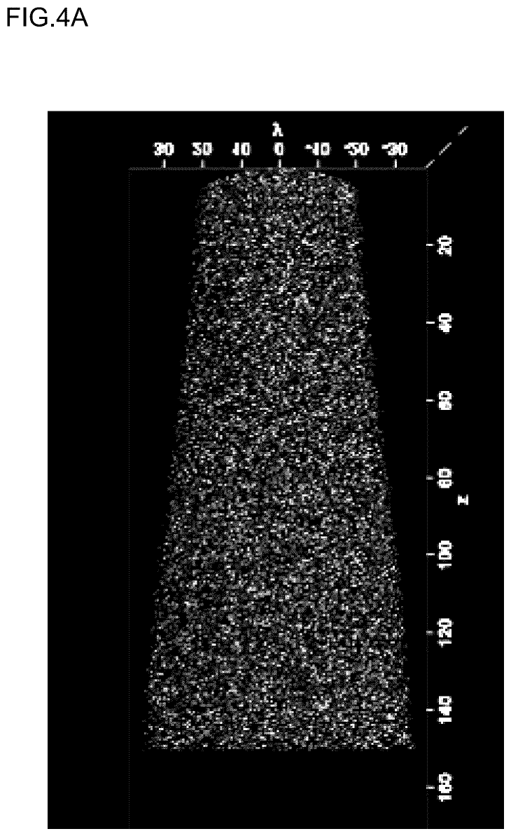

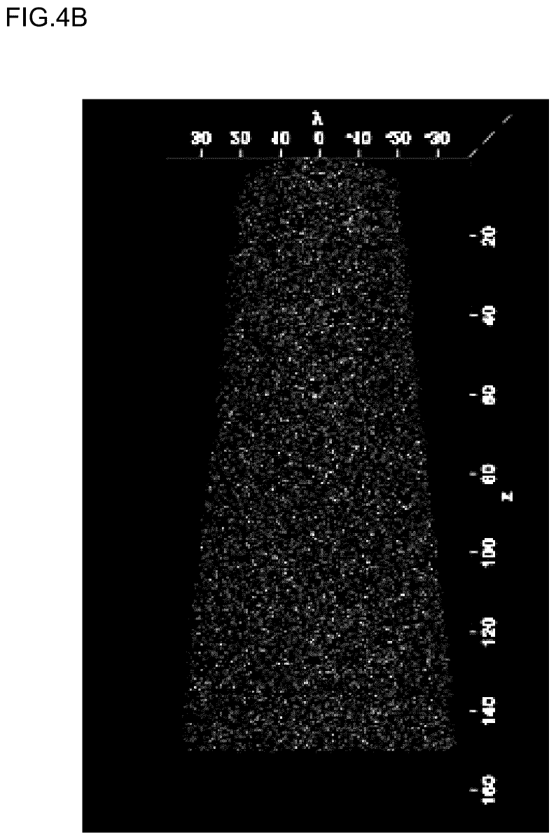

An observation area of 3DAP was set to an area of 10 nm×10 nm×200 nm. Said observation area was divided into 2500 cubic grids each of which were a cube of 2 nm×2 nm×2 nm, and a content ratio of iron (Fe) and a content ratio of cobalt (Co) in each grid were calculated. Regarding the surface part of Sample No. 9a, an observation result of iron distribution using 3DAP is shown in FIG. 4A, and an observation result of cobalt distribution using 3DAP is shown in FIG. 4B.

The calculated content ratios of iron and cobalt were used to calculate a sum (a total content ratio) of the content ratio of iron and the content ratio of cobalt in each grid. Using the calculated data of 2500 grids as a population, a standard deviation σ_{FeCo} of the sum of the content ratios of iron and cobalt were calculated. The standard deviation σ_{FeCo} of the surface part was represented by σ_{FeCo}(S) and the standard deviation σ_{FeCo} of the center part was represented by σ_{FeCo}(C). The obtained σ_{FeCo}(C) was subtracted from the obtained σ_{FeCo}(S), thereby σ_{FeCo}(S)−σ_{FeCo}(C) was calculated. The results are shown in Table 1.

Note that, a number ratio of the particles having σ_{FeCo}(S)−σ_{FeCo}(C) within the above-mentioned range was 65% or greater in all of the samples of Sample Nos. 2a to 9d. Also, among Sample Nos. 11 to 417, the sample of an odd number having a number ratio of the particles of σ_{FeCo}(S)−σ_{FeCo}(C) within the above-mentioned range was 65% or greater.

Regarding Sample Nos. 1a to 9d, the obtained soft magnetic powder (large size powder) and the pure iron powder (small size powder) were mixed in which a ratio of the large size powder was 80 mass % and a ratio of the small size powder was 20 mass %, thereby a mixed powder was obtained. The obtained mixed powder was kneaded with an epoxy resin to produce a mixture. A blending amount of the epoxy resin was 2.5 parts by mass with respect to 100 parts by mass of the mixed powder.

For each of Sample Nos. 1a to 1d, a mold having a predetermined toroidal shape was filled with the obtained mixture, and molded bodies with different filling rates of the mixed powder were obtained by changing the pressure. The epoxy resin included in the obtained molded body was heat cured at 180° C. for 60 minutes, thereby a toroidal core (an outer diameter 11 mm, an inner diameter 6.5 mm, a thickness 2.5 mm) was produced. The filling rate of the mixed powder in the obtained toroidal core is shown in Table 1. Note that, a density of the toroidal core calculated from a size and a mass of the toroidal core was divided by a theoretical density of the toroidal core calculated from a specific gravity of each material, thereby the filling rate of the mixed powder of the core was calculated.

A copper wire was wound around each sample of the toroidal cores of Sample Nos. 1a to 1d, and an inductance of the toroidal core at a frequency of 1 MHz was measured using an impedance analyzer. A specific permeability was calculated from the obtained inductance, and this value was defined as an initial specific permeability μi. The results are shown in Table 1.

Next, using a BH analyzer (SY-8218 made by IWATSU ELECTRIC CO., LTD.) to each sample of the toroidal cores of Sample Nos. 1a to 1d to which the copper wire was wound, a core loss Pcv (unit: kW/m³) was measured. A magnetic flux density when the core loss was measured was set to 10 mT, and a frequency was set to 3 MHz. The results are shown in Table 1.

Using μi and the filling rates of the toroidal cores of Sample Nos. 1a to 1d, a regression line showing the relation of μi and the filling rate was calculated, and μi where the filling rate was 80% on the regression line was indicated as “μi at 80%”. The results are shown in Table 1.

Also, using Pcv and the filling rates of the toroidal cores of Sample Nos. 1a to 1d, a regression line showing the relation of Pcv and the filling rate was calculated, and Pcv where the filling rate was 80% on the regression line was indicated as “Pcv at 80%” (kW/m³). The results are shown in Table 1.

Regarding Sample Nos. 2a to 2d, Sample Nos. 3a to 3d, Sample Nos. 4a to 4d, Sample Nos. 5a to 5d, Sample Nos. 6a to 6d, Sample Nos. 7a to 7d, Sample Nos. 8a to 8d, and Sample Nos. 9a to 9d, the mixed powders and the toroidal cores were produced using the same method as in the case of Sample Nos. 1a to 1d by using the obtained soft magnetic powder. Also, the magnetic properties of the toroidal core were evaluated using the same methods as in the case of 1a to 1d to calculate “μi at 80%” and “Pcv at 80%”.

A μi improvement rate (%) was obtained by calculating a relative value of “μi at 80%” of the above with respect to the values of “μi at 80%” of Sample Nos. 1a to 1d which were considered as 100%. The larger the μi improvement rate is, the higher the magnetic permeability of the obtained magnetic core is. In the present examples, samples having the μi improvement rate of 105% or higher were considered good. The results are shown in Table 1.

Also, a Pcv reduction rate (%) was obtained by calculating a relative value of “Pcv at 80%” of the above with respect to the values of “Pcv at 80%” of Sample Nos. 1a to 1d which were considered as 100%. The smaller the Pcv reduction rate is, the smaller the core loss of the obtained magnetic core is. In the present examples, samples having the Pcv reduction rate of 95% or smaller were considered good. The results are shown in Table 1.

TABLE 1

| | Example/ | Surface reducing | | FeCo Concentration in | | | Filling | Magnetic | | | | μi | Pcv re- |
|---|---|---|---|---|---|---|---|---|---|---|---|---|---|
| | Compar- | treatment | | Soft magnetic particle | | | rate of | properties | | | Pcv | impovement | duction |
| Sample | ative | Temp. | Atmo- | σ_{FeCo} | σ_{FeCo} | σ_{FeCo} (S) − | mixed | | Pcv | μi | at 80% | rate | rate |
| No. | example | (° C.) | sphere | (S) | (C) | σ_{FeCo} (C) | powder (%) | μi | (kW/m³) | at 80% | (kW/m³) | (%) | (%) |
| 1a | Comparative | — | — | 1.878 | 1.880 | −0.002 | 71.7 | 24 | 1795 | 29 | 1677 | 100 | 100 |
| | example | | | | | | | | | | | | |
| 1b | Comparative | | | | | | 75.8 | 26 | 1680 | | | | |
| | example | | | | | | | | | | | | |
| 1c | Comparative | | | | | | 81.6 | 29 | 1696 | | | | |
| | example | | | | | | | | | | | | |
| 1d | Comparative | | | | | | 86.0 | 35 | 1595 | | | | |
| | example | | | | | | | | | | | | |
| 2a | Example | 900 | Ar + | 1.443 | 1.847 | −0.404 | 71.1 | 34 | 1251 | 43 | 1177 | 145 | 70 |
| 2b | Example | | H₂ (3%) + | | | | 77.0 | 40 | 1198 | | | | |
| 2c | Example | | CH₄ (4%) | | | | 80.5 | 44 | 1165 | | | | |
| 2d | Example | | | | | | 86.5 | 49 | 1131 | | | | |
| 3a | Example | 800 | Ar + | 1.501 | 1.850 | −0.349 | 70.3 | 33 | 1307 | 42 | 1217 | 141 | 73 |
| 3b | Example | | H₂ (3%) + | | | | 76.4 | 36 | 1212 | | | | |
| 3c | Example | | CH₄ (4%) | | | | 81.2 | 42 | 1218 | | | | |
| 3d | Example | | | | | | 85.0 | 48 | 1185 | | | | |
| 4a | Example | 700 | Ar + | 1.569 | 1.842 | −0.273 | 70.5 | 30 | 1344 | 39 | 1265 | 131 | 75 |
| 4b | Example | | H₂ (3%) + | | | | 76.0 | 34 | 1297 | | | | |
| 4c | Example | | CH₄ (4%) | | | | 80.5 | 39 | 1241 | | | | |
| 4d | Example | | | | | | 87.3 | 46 | 1221 | | | | |
| 5a | Example | 600 | Ar + | 1.623 | 1.820 | −0.197 | 70.3 | 27 | 1490 | 37 | 1396 | 124 | 83 |
| 5b | Example | | H₂ (3%) + | | | | 75.6 | 33 | 1423 | | | | |
| 5c | Example | | CH₄ (4%) | | | | 81.5 | 38 | 1377 | | | | |
| 5d | Example | | | | | | 86.5 | 43 | 1347 | | | | |
| 6a | Example | 575 | Ar + | 1.798 | 1.818 | −0.020 | 70.8 | 27 | 1505 | 35 | 1439 | 118 | 86 |
| 6b | Example | | H₂ (3%) + | | | | 75.2 | 31 | 1487 | | | | |
| 6c | Example | | CH₄ (4%) | | | | 80.8 | 35 | 1432 | | | | |
| 6d | Example | | | | | | 85.0 | 39 | 1397 | | | | |
| 7a | Example | 550 | Ar + | 1.802 | 1.812 | −0.010 | 71.1 | 27 | 1600 | 32 | 1512 | 110 | 90 |
| 7b | Example | | H₂ (3%) + | | | | 75.3 | 29 | 1595 | | | | |
| 7c | Example | | CH₄ (4%) | | | | 81.0 | 33 | 1510 | | | | |
| 7d | Example | | | | | | 85.2 | 36 | 1433 | | | | |
| 8a | Example | 500 | Ar + | 1.801 | 1.806 | −0.005 | 72.2 | 27 | 1673 | 31 | 1593 | 105 | 95 |
| 8b | Example | | H₂ (3%) + | | | | 75.5 | 28 | 1656 | | | | |
| 8c | Example | | CH₄ (4%) | | | | 80.6 | 32 | 1587 | | | | |
| 8d | Example | | | | | | 87.0 | 35 | 1511 | | | | |
| 9a | Example | 1000 | Ar + | 1.387 | 1.844 | −0.457 | 71.4 | 37 | 1195 | 45 | 1123 | 152 | 67 |
| 9b | Example | | H₂ (3%) + | | | | 75.7 | 42 | 1162 | | | | |
| 9c | Example | | CH₄ (4%) | | | | 80.3 | 46 | 1114 | | | | |
| 9d | Example | | | | | | 86.4 | 50 | 1073 | | | | |

According to Table 1, in the case that σ_{FeCo}(S)−σ_{FeCo}(C) was within the above-mentioned range, the μi improvement rate tends to be larger, and the Pcv reduction rate tends to be smaller, thus it was confirmed that a magnetic core having a high permeability and a low loss can be obtained.

### Experiment 2

For each sample of an even number, the mixed powder and the toroidal core were produced by the same method as in the case of Sample Nos. 1a to 1d except that the composition of the soft magnetic powder (large size powder) shown in Tables 2 to 12 was used. Further, magnetic properties of the toroidal core were evaluated using the same method as in the case of Sample Nos. 1a to 1d, thereby μi and Pcv at the filling rates shown in Tables 2 to 12 were calculated. That is, in Tables 2 to 12, each sample number consists of four samples, and magnetic properties of these four samples were used to calculate μi and Pcv at the predetermined filling rate of each sample number, which is the same as in the case of Experiment 1. Results are shown in Tables 2 to 12.

For each sample of an odd number shown in Tables 2 to 6, the mixed powder was produced by the same method as in the case of Sample Nos. 2a to 2d except that the soft magnetic powder (large size powders) having the composition as shown in Tables 2 to 6 was used. Also, for each sample number of an odd number shown in Tables 7 to 12, the mixed powder was produced by the same method as in the case of Sample Nos. 2a to 2d except that the soft magnetic powder (large size powders) having the composition as shown in Tables 7 to 12 was used, and a temperature shown in Tables 7 to 12 was used as a heating temperature of a surface reducing treatment. The obtained mixed powder was used to produce toroidal core using the same method as in the case of Sample Nos. 2a to 2d. Magnetic properties of the toroidal core were evaluated by the same method as in the case of Sample Nos. 2a to 2d, thereby μi and Pcv at the filling rates shown in Tables 2 to 12 were calculated. Using the calculated μi and Pcv, a μi improvement rate with respect to μi of the sample number having the same composition, and a Pcv reduction rate with respect to Pcv of the same sample number were calculated. For example, the μi improvement rate and the Pcv reduction rate of Sample No. 11 were the relative values when μi and Pcv of Sample No. 10 having the same composition was considered 100%. The results are shown in Tables 2 to 12.

TABLE 2

| | | | Surface reducing treatment | | | | |
|---|---|---|---|---|---|---|---|
| | Example/ | | Heating | | FeCo Concentration in Soft magnetic particle | | |
| Sample | Comparative | | temp. | | | | σ_{FeCo} (S) − |
| No. | example | Composition | (° C.) | Atmosphere | σ_{FeCo} (S) | σ_{FeCo} (C) | σ_{FeCo} (C) |
| 10 | Comparative | Fe₉₇Si₃ | — | — | 1.140 | 1.142 | −0.002 |
| | example | | | | | | |
| 11 | Example | | 900 | Ar + H₂ (3%) + CH₄ (4%) | 1.011 | 1.149 | −0.138 |
| 12 | Comparative | Fe₉₅Si₅ | — | — | 1.211 | 1.212 | −0.001 |
| | example | | | | | | |
| 13 | Example | | 900 | Ar + H₂ (3%) + CH₄ (4%) | 1.039 | 1.239 | −0.200 |
| 14 | Comparative | Fe₉₃Si₇ | — | — | 1.434 | 1.436 | −0.002 |
| | example | | | | | | |
| 15 | Example | | 900 | Ar + H₂ (3%) + CH₄ (4%) | 1.140 | 1.419 | −0.279 |
| 16 | Comparative | Fe₉₀Si₁₀ | — | — | 1.712 | 1.714 | −0.002 |
| | example | | | | | | |
| 17 | Example | | 900 | Ar + H₂ (3%) + CH₄ (4%) | 1.336 | 1.742 | −0.406 |
| 18 | Comparative | Fe₈₈Si₁₂ | — | — | 1.878 | 1.877 | 0.001 |
| | example | | | | | | |
| 19 | Example | | 900 | Ar + H₂ (3%) + CH₄ (4%) | 1.389 | 1.867 | −0.478 |
| 20 | Comparative | Fe₈₅Si₁₅ | — | — | 2.101 | 2.101 | 0.000 |
| | example | | | | | | |
| 21 | Example | | 900 | Ar + H₂ (3%) + CH₄ (4%) | 1.416 | 2.086 | −0.671 |
| 22 | Comparative | Fe₈₀Si₂₀ | — | — | 2.423 | 2.426 | −0.003 |
| | example | | | | | | |
| 23 | Example | | 900 | Ar + H₂ (3%) + CH₄ (4%) | 1.726 | 2.444 | −0.718 |
| 24 | Comparative | Fe₇₅Si₂₅ | — | — | 2.479 | 2.481 | −0.002 |
| | example | | | | | | |
| 25 | Example | | 900 | Ar + H₂ (3%) + CH₄ (4%) | 2.007 | 2.480 | −0.473 |
| 26 | Comparative | Fe₇₀Si₃₀ | — | — | 2.497 | 2.498 | −0.001 |
| | example | | | | | | |
| 27 | Example | | 900 | Ar + H₂ (3%) + CH₄ (4%) | 1.992 | 2.495 | −0.503 |

| | | Filling | | | | |
|---|---|---|---|---|---|---|
| | | rate of | Magnetic properties | | μi | Pcv |
| | Example/ | mixied | | Pcv | impovement | reduction |
| Sample | Comparative | powder | μi | at 80% | rate | rate |
| No. | example | (%) | at 80% | (kW/m³) | (%) | (%) |
| 10 | Comparative | 80 | 34 | 1410 | 100 | 100 |
| | example | | | | | |
| 11 | Example | 80 | 36 | 1312 | 106 | 93 |
| 12 | Comparative | 80 | 37 | 1374 | 100 | 100 |
| | example | | | | | |
| 13 | Example | 80 | 49 | 1058 | 133 | 77 |
| 14 | Comparative | 80 | 37 | 1327 | 100 | 100 |
| | example | | | | | |
| 15 | Example | 80 | 55 | 1035 | 147 | 78 |
| 16 | Comparative | 80 | 38 | 1247 | 100 | 100 |
| | example | | | | | |
| 17 | Example | 80 | 51 | 972 | 133 | 78 |
| 18 | Comparative | 80 | 38 | 1223 | 100 | 100 |
| | example | | | | | |
| 19 | Example | 80 | 51 | 856 | 135 | 70 |
| 20 | Comparative | 80 | 38 | 1246 | 100 | 100 |
| | example | | | | | |
| 21 | Example | 80 | 53 | 922 | 140 | 74 |
| 22 | Comparative | 81 | 38 | 1149 | 100 | 100 |
| | example | | | | | |
| 23 | Example | 81 | 56 | 839 | 146 | 73 |
| 24 | Comparative | 80 | 38 | 1139 | 100 | 100 |
| | example | | | | | |
| 25 | Example | 80 | 54 | 901 | 142 | 79 |
| 26 | Comparative | 80 | 38 | 1141 | 100 | 100 |
| | example | | | | | |
| 27 | Example | 80 | 41 | 1034 | 108 | 91 |

TABLE 3

| | | | Surface reducing treatment | | | | |
|---|---|---|---|---|---|---|---|
| | Example/ | | Heating | | FeCo Concentration in Soft magnetic particle | | |
| Sample | Comparative | | temp. | | | | σ_{FeCo} (S) − |
| No. | example | Composition | (° C.) | Atmosphere | σ_{FeCo} (S) | σ_{FeCo} (C) | σ_{FeCo} (C) |
| 16 | Comparative | Fe₉₀Si₁₀ | — | — | 1.712 | 1.714 | −0.002 |
| | example | | | | | | |
| 17 | Example | | 900 | Ar + H₂ (3%) + CH₄ (4%) | 1.336 | 1.742 | −0.406 |
| 28 | Comparative | (Fe_{0.95}Co_{0.05})₉₀Si₁₀ | — | — | 1.714 | 1.714 | 0.000 |
| | example | | | | | | |
| 29 | Example | | 900 | Ar + H₂ (3%) + CH₄ (4%) | 1.354 | 1.746 | −0.392 |
| 30 | Comparative | (Fe_{0.9}Co_{0.1})₉₀Si₁₀ | — | — | 1.718 | 1.715 | 0.003 |
| | example | | | | | | |
| 31 | Example | | 900 | Ar + H₂ (3%) + CH₄ (4%) | 1.343 | 1.735 | −0.392 |
| 1 | Comparative | (Fe_{0.75}Co_{0.25})₉₀Si₁₀ | — | — | 1.878 | 1.880 | −0.002 |
| | example | | | | | | |
| 2 | Example | | 900 | Ar + H₂ (3%) + CH₄ (4%) | 1.443 | 1.847 | −0.404 |
| 32 | Comparative | (Fe_{0.6}Co_{0.4})₉₀Si₁₀ | — | — | 1.713 | 1.715 | −0.002 |
| | example | | | | | | |
| 33 | Example | | 900 | Ar + H₂ (3%) + CH₄ (4%) | 1.272 | 1.681 | −0.409 |
| 34 | Comparative | (Fe_{0.5}Co_{0.5})₉₀Si₁₀ | — | — | 1.713 | 1.715 | −0.002 |
| | example | | | | | | |
| 35 | Example | | 900 | Ar + H₂ (3%) + CH₄ (4%) | 1.269 | 1.705 | −0.436 |
| 36 | Comparative | (Fe_{0.25}Co_{0.75})₉₀Si₁₀ | — | — | 1.752 | 1.751 | 0.001 |
| | example | | | | | | |
| 37 | Example | | 900 | Ar + H₂ (3%) + CH₄ (4%) | 1.310 | 1.701 | −0.391 |
| 38 | Comparative | Co₉₀Si₁₀ | — | — | 1.765 | 1.767 | −0.002 |
| | example | | | | | | |
| 39 | Example | | 900 | Ar + H₂ (3%) + CH₄ (4%) | 1.299 | 1.697 | −0.398 |

| | | Filling | | | | |
|---|---|---|---|---|---|---|
| | | rate of | Magnetic properties | | μi | Pcv |
| | Example/ | mixed | | Pcv | impovement | reduction |
| Sample | Comparative | powder | μi | at 80% | rate | rate |
| No. | example | (%) | at 80% | (kW/m³) | (%) | (%) |
| 16 | Comparative | 80 | 38 | 1247 | 100 | 100 |
| | example | | | | | |
| 17 | Example | 80 | 51 | 972 | 133 | 78 |
| 28 | Comparative | 80 | 37 | 1340 | 100 | 100 |
| | example | | | | | |
| 29 | Example | 80 | 49 | 978 | 135 | 73 |
| 30 | Comparative | 80 | 35 | 1477 | 100 | 100 |
| | example | | | | | |
| 31 | Example | 80 | 48 | 1123 | 137 | 76 |
| 1 | Comparative | 80 | 29 | 1677 | 100 | 100 |
| | example | | | | | |
| 2 | Example | 80 | 43 | 1177 | 148 | 70 |
| 32 | Comparative | 80 | 30 | 1992 | 100 | 100 |
| | example | | | | | |
| 33 | Example | 80 | 39 | 1554 | 130 | 78 |
| 34 | Comparative | 80 | 24 | 2143 | 100 | 100 |
| | example | | | | | |
| 35 | Example | 80 | 33 | 1628 | 140 | 76 |
| 36 | Comparative | 80 | 22 | 2205 | 100 | 100 |
| | example | | | | | |
| 37 | Example | 80 | 25 | 1904 | 114 | 86 |
| 38 | Comparative | 80 | 2 | 2346 | 100 | 100 |
| | example | | | | | |
| 39 | Example | 80 | 23 | 1881 | 110 | 80 |

TABLE 4

| | | | Surface reducing treatment | | | | |
|---|---|---|---|---|---|---|---|
| | Example/ | | Heating | | FeCo Concentration in Soft magnetic particle | | |
| Sample | Comparative | | temp. | | | | σ_{FeCo} (S) − |
| No. | example | Composition | (° C.) | Atmosphere | σ_{FeCo} (S) | σ_{FeCo} (C) | σ_{FeCo} (C) |
| 16 | Comparative | Fe₉₀Si₁₀ | — | — | 1.712 | 1.714 | −0.002 |
| | example | | | | | | |
| 17 | Example | | 900 | Ar + H₂ (3%) + CH₄ (4%) | 1.336 | 1.742 | −0.406 |
| 40 | Comparative | Fe_{89.8}Si₁₀Cr_{0.2} | — | — | 1.898 | 1.898 | 0.000 |
| | example | | | | | | |
| 41 | Example | | 900 | Ar + H₂ (3%) + CH₄ (4%) | 1.348 | 1.750 | −0.402 |
| 42 | Comparative | Fe_{89.5}Si₁₀Cr_{0.5} | — | — | 1.929 | 1.926 | 0.003 |
| | example | | | | | | |
| 43 | Example | | 900 | Ar + H₂ (3%) + CH₄ (4%) | 1.270 | 1.768 | −0.498 |
| 44 | Comparative | Fe₈₉Si₁₀Cr₁ | — | — | 1.971 | 1.969 | 0.002 |
| | example | | | | | | |
| 45 | Example | | 900 | Ar + H₂ (3%) + CH₄ (4%) | 1.271 | 1.786 | −0.515 |
| 46 | Comparative | Fe₈₈Si₁₀Cr₂ | — | — | 2.060 | 2.058 | 0.002 |
| | example | | | | | | |
| 47 | Example | | 900 | Ar + H₂ (3%) + CH₄ (4%) | 1.261 | 1.842 | −0.581 |
| 48 | Comparative | Fe₈₈Si₇Cr₅ | — | — | 1.878 | 1.877 | 0.001 |
| | example | | | | | | |
| 49 | Example | | 900 | Ar + H₂ (3%) + CH₄ (4%) | 1.316 | 1.739 | −0.423 |
| 50 | Comparative | Fe₈₆Si₇Cr₇ | — | — | 2.302 | 2.303 | −0.001 |
| | example | | | | | | |
| 51 | Example | | 900 | Ar + H₂ (3%) + CH₄ (4%) | 1.348 | 1.988 | −0.641 |
| 52 | Comparative | Fe₈₅Si₇Cr₈ | — | — | 1.986 | 1.987 | −0.001 |
| | example | | | | | | |
| 53 | Example | | 900 | Ar + H₂ (3%) + CH₄ (4%) | 1.371 | 1.980 | −0.609 |
| 54 | Comparative | (Fe_{0.9}Co_{0.1})₈₈Si₁₂ | — | — | 1.981 | 1.981 | 0.000 |
| | example | | | | | | |
| 55 | Example | | 900 | Ar + H₂ (3%) + CH₄ (4%) | 1.316 | 1.977 | −0.661 |
| 56 | Comparative | (Fe_{0.9}Co_{0.1})_{87.8}Si₁₂Cr_{0.2} | — | — | 2.070 | 2.073 | −0.003 |
| | example | | | | | | |
| 57 | Example | | 900 | Ar + H₂ (3%) + CH₄ (4%) | 1.312 | 1.854 | −0.542 |
| 58 | Comparative | (Fe_{0.9}Co_{0.1})_{87.5}Si₁₂Cr_{0.5} | — | — | 2.098 | 2.101 | −0.003 |
| | example | | | | | | |
| 59 | Example | | 900 | Ar + H₂ (3%) + CH₄ (4%) | 1.300 | 1.864 | −0.564 |
| 60 | Comparative | (Fe_{0.9}Co_{0.1})₈₇Si₁₂Cr₁ | — | — | 2.141 | 2.142 | −0.001 |
| | example | | | | | | |
| 61 | Example | | 900 | Ar + H₂ (3%) + CH₄ (4%) | 1.411 | 1.894 | −0.482 |
| 62 | Comparative | (Fe_{0.9}Co_{0.1})₈₆Si₁₂Cr₂ | — | — | 2.225 | 2.222 | 0.003 |
| | example | | | | | | |
| 63 | Example | | 900 | Ar + H₂ (3%) + CH₄ (4%) | 1.353 | 1.935 | −0.582 |
| 64 | Comparative | (Fe_{0.9}Co_{0.1})₈₈Si₇Cr₅ | — | — | 1.879 | 1.880 | −0.001 |
| | example | | | | | | |
| 65 | Example | | 900 | Ar + H₂ (3%) + CH₄ (4%) | 1.304 | 1.733 | −0.429 |
| 66 | Comparative | (Fe_{0.9}Co_{0.1})₈₆Si₇Cr₇ | — | — | 2.301 | 2.303 | −0.002 |
| | example | | | | | | |
| 67 | Example | | 900 | Ar + H₂ (3%) + CH₄ (4%) | 1.320 | 1.985 | −0.665 |
| 1 | Comparative | (Fe_{0.75}Co_{0.25})₉₀Si₁₀ | — | — | 1.878 | 1.880 | −0.002 |
| | example | | | | | | |
| 2 | Example | | 900 | Ar + H₂ (3%) + CH₄ (4%) | 1.443 | 1.847 | −0.404 |
| 68 | Comparative | (Fe_{0.75}Co_{0.25})_{89.8}Si₁₀Cr_{0.2} | — | — | 1.897 | 1.897 | 0.000 |
| | example | | | | | | |
| 69 | Example | | 900 | Ar + H₂ (3%) + CH₄ (4%) | 1.306 | 1.747 | −0.442 |
| 70 | Comparative | (Fe_{0.75}Co_{0.25})_{89.5}Si₁₀Cr_{0.5} | — | — | 1.925 | 1.923 | 0.002 |
| | example | | | | | | |
| 71 | Example | | 900 | Ar + H₂ (3%) + CH₄ (4%) | 1.372 | 1.758 | −0.386 |
| 72 | Comparative | (Fe_{0.75}Co_{0.25})₈₉Si₁₀Cr₁ | — | — | 1.970 | 1.971 | −0.001 |
| | example | | | | | | |
| 73 | Example | | 900 | Ar + H₂ (3%) + CH₄ (4%) | 1.293 | 1.788 | −0.495 |
| 74 | Comparative | (Fe_{0.75}Co_{0.25})₈₈Si₁₀Cr₂ | — | — | 2.058 | 2.057 | 0.001 |
| | example | | | | | | |
| 75 | Example | | 900 | Ar + H₂ (3%) + CH₄ (4%) | 1.266 | 1.847 | −0.581 |
| 76 | Comparative | (Fe_{0.75}Co_{0.25})₈₈Si₇Cr₅ | — | — | 1.881 | 1.878 | 0.003 |
| | example | | | | | | |
| 77 | Example | | 900 | Ar + H₂ (3%) + CH₄ (4%) | 1.358 | 1.733 | −0.375 |
| 78 | Comparative | (Fe_{0.75}Co_{0.25})₈₆Si₇Cr₇ | — | — | 2.303 | 2.300 | 0.003 |
| | example | | | | | | |
| 79 | Example | | 900 | Ar + H₂ (3%) + CH₄ (4%) | 1.232 | 1.980 | −0.749 |

| | | Filling rate of | Magnetic properties | | | Pcv |
|---|---|---|---|---|---|---|
| | Example/ | mixed | | Pcv | μi | reduction |
| Sample | Comparative | powder | μi | at 80% | impovement | rate |
| No. | example | (%) | at 80% | (kW/m³) | rate (%) | (%) |
| 16 | Comparative | 80 | 38 | 1247 | 100 | 100 |
| | example | | | | | |
| 17 | Example | 80 | 51 | 972 | 133 | 78 |
| 40 | Comparative | 80 | 37 | 1263 | 100 | 100 |
| | example | | | | | |
| 41 | Example | 80 | 54 | 973 | 145 | 77 |
| 42 | Comparative | 80 | 37 | 1256 | 100 | 100 |
| | example | | | | | |
| 43 | Example | 80 | 57 | 967 | 153 | 77 |
| 44 | Comparative | 80 | 37 | 1292 | 100 | 100 |
| | example | | | | | |
| 45 | Example | 80 | 51 | 1033 | 137 | 80 |
| 46 | Comparative | 80 | 37 | 1281 | 100 | 100 |
| | example | | | | | |
| 47 | Example | 80 | 55 | 897 | 150 | 70 |
| 48 | Comparative | 80 | 37 | 1378 | 100 | 100 |
| | example | | | | | |
| 49 | Example | 80 | 48 | 1075 | 130 | 78 |
| 50 | Comparative | 80 | 37 | 1345 | 100 | 100 |
| | example | | | | | |
| 51 | Example | 80 | 55 | 955 | 148 | 71 |
| 52 | Comparative | 80 | 37 | 1372 | 100 | 100 |
| | example | | | | | |
| 53 | Example | 80 | 40 | 1289 | 108 | 94 |
| 54 | Comparative | 80 | 37 | 1389 | 100 | 100 |
| | example | | | | | |
| 55 | Example | 80 | 48 | 1102 | 130 | 79 |
| 56 | Comparative | 80 | 35 | 1443 | 100 | 100 |
| | example | | | | | |
| 57 | Example | 80 | 47 | 1111 | 133 | 77 |
| 58 | Comparative | 80 | 35 | 1399 | 100 | 100 |
| | example | | | | | |
| 59 | Example | 80 | 46 | 1049 | 132 | 75 |
| 60 | Comparative | 80 | 36 | 1411 | 100 | 100 |
| | example | | | | | |
| 61 | Example | 80 | 44 | 1115 | 123 | 79 |
| 62 | Comparative | 80 | 36 | 1378 | 100 | 100 |
| | example | | | | | |
| 63 | Example | 80 | 49 | 1102 | 135 | 80 |
| 64 | Comparative | 80 | 33 | 1481 | 100 | 100 |
| | example | | | | | |
| 65 | Example | 80 | 43 | 1140 | 131 | 77 |
| 66 | Comparative | 80 | 33 | 1501 | 100 | 100 |
| | example | | | | | |
| 67 | Example | 80 | 45 | 1111 | 137 | 74 |
| 1 | Comparative | 80 | 29 | 1677 | 100 | 100 |
| | example | | | | | |
| 2 | Example | 80 | 43 | 1177 | 148 | 70 |
| 68 | Comparative | 80 | 29 | 1725 | 100 | 100 |
| | example | | | | | |
| 69 | Example | 80 | 43 | 1242 | 149 | 72 |
| 70 | Comparative | 80 | 29 | 1740 | 100 | 100 |
| | example | | | | | |
| 71 | Example | 80 | 42 | 1218 | 142 | 70 |
| 72 | Comparative | 80 | 29 | 1748 | 100 | 100 |
| | example | | | | | |
| 73 | Example | 80 | 40 | 1398 | 140 | 80 |
| 74 | Comparative | 80 | 29 | 1719 | 100 | 100 |
| | example | | | | | |
| 75 | Example | 80 | 38 | 1341 | 130 | 78 |
| 76 | Comparative | 80 | 29 | 1738 | 100 | 100 |
| | example | | | | | |
| 77 | Example | 80 | 37 | 1251 | 129 | 72 |
| 78 | Comparative | 80 | 29 | 1736 | 100 | 100 |
| | example | | | | | |
| 79 | Example | 80 | 42 | 1354 | 144 | 78 |

TABLE 5

| | | | Surface reducing treatment | | | | |
|---|---|---|---|---|---|---|---|
| | Example/ | | Heating | | FeCo Concentration in Soft magnetic particle | | |
| Sample | Comparative | | temp. | | | | σ_{FeCo} (S) − |
| No. | example | Composition | (° C.) | Atmosphere | σ_{FeCo} (S) | σ_{FeCo} (C) | σ_{FeCo} (C) |
| 80 | Comparative | Fe₈₆Si₁₂Cr₂ | — | — | 2.101 | 2.099 | 0.002 |
| | example | | | | | | |
| 81 | Example | | 900 | Ar + H₂ (3%) + CH₄ (4%) | 1.635 | 2.076 | −0.441 |
| 82 | Comparative | Fe_{85.5}Si₁₂C_{0.5}Cr₂ | — | — | 2.260 | 2.261 | −0.001 |
| | example | | | | | | |
| 83 | Example | | 900 | Ar + H₂ (3%) + CH₄ (4%) | 1.388 | 1.969 | −0.581 |
| 84 | Comparative | Fe₈₄Si₁₂C₂Cr₂ | — | — | 2.381 | 2.378 | 0.003 |
| | example | | | | | | |
| 85 | Example | | 900 | Ar + H₂ (3%) + CH₄ (4%) | 1.254 | 2.032 | −0.778 |
| 86 | Comparative | Fe_{85.5}Si₁₂Cr₂Al_{0.5} | — | — | 2.259 | 2.260 | −0.001 |
| | example | | | | | | |
| 87 | Example | | 900 | Ar + H₂ (3%) + CH₄ (4%) | 1.275 | 1.969 | −0.695 |
| 88 | Comparative | Fe₈₄Si₁₂Cr₂Al₂ | — | — | 2.377 | 2.376 | 0.001 |
| | example | | | | | | |
| 89 | Example | | 900 | Ar + H₂ (3%) + CH₄ (4%) | 1.386 | 2.025 | −0.638 |
| 90 | Comparative | Fe_{85.975}Si₁₂Cr₂S_{0.025} | — | — | 2.225 | 2.223 | 0.002 |
| | example | | | | | | |
| 91 | Example | | 900 | Ar + H₂ (3%) + CH₄ (4%) | 1.400 | 1.938 | −0.537 |
| 92 | Comparative | Fe_{85.9}Si₁₂Cr₂S_{0.1} | — | — | 2.234 | 2.231 | 0.003 |
| | example | | | | | | |
| 93 | Example | | 900 | Ar + H₂ (3%) + CH₄ (4%) | 1.281 | 1.948 | −0.667 |
| 94 | Comparative | Fe_{85.5}Si₁₂Cr₂Ti_{0.5} | — | — | 2.262 | 2.261 | 0.001 |
| | example | | | | | | |
| 95 | Example | | 900 | Ar + H₂ (3%) + CH₄ (4%) | 1.300 | 1.961 | −0.661 |
| 96 | Comparative | Fe₈₄Si₁₂Cr₂Ti₂ | — | — | 2.377 | 2.377 | 0.000 |
| | example | | | | | | |
| 97 | Example | | 900 | Ar + H₂ (3%) + CH₄ (4%) | 1.355 | 2.032 | −0.677 |
| 98 | Comparative | Fe_{85.5}Si₁₂Cr₂V_{0.5} | — | — | 2.266 | 2.263 | 0.003 |
| | example | | | | | | |
| 99 | Example | | 900 | Ar + H₂ (3%) + CH₄ (4%) | 1.264 | 1.963 | −0.699 |
| 100 | Comparative | Fe₈₄Si₁₂Cr₂V₂ | — | — | 2.376 | 2.378 | −0.002 |
| | example | | | | | | |
| 10 | Example | | 900 | Ar + H₂ (3%) + CH₄ (4%) | 1.402 | 2.029 | −0.627 |
| 102 | Comparative | Fe_{85.5}Si₁₂Cr₂Mn_{0.5} | — | — | 2.264 | 2.261 | 0.003 |
| | example | | | | | | |
| 103 | Example | | 900 | Ar + H₂ (3%) + CH₄ (4%) | 1.338 | 1.968 | −0.631 |
| 104 | Comparative | Fe₈₄Si₁₂Cr₂Mn₂ | — | — | 2.377 | 2.374 | 0.003 |
| | example | | | | | | |
| 105 | Example | | 900 | Ar + H₂ (3%) + CH₄ (4%) | 1.443 | 2.035 | −0.592 |
| 106 | Comparative | Fe_{85.5}Si₁₂Cr₂Ni_{0.5} | — | — | 2.257 | 2.260 | −0.003 |
| | example | | | | | | |
| 107 | Example | | 900 | Ar + H₂ (3%) + CH₄ (4%) | 1.318 | 1.965 | −0.647 |
| 108 | Comparative | Fe₈₄Si₁₂Cr₂Ni₂ | — | — | 2.376 | 2.378 | −0.002 |
| | example | | | | | | |
| 109 | Example | | 900 | Ar + H₂ (3%) + CH₄ (4%) | 1.351 | 2.029 | −0.678 |
| 110 | Comparative | Fe_{85.5}Si₁₂Cr₂Cu_{0.5} | — | — | 2.264 | 2.264 | 0.000 |
| | example | | | | | | |
| 111 | Example | | 900 | Ar + H₂ (3%) + CH₄ (4%) | 1.393 | 1.960 | −0.567 |
| 112 | Comparative | Fe₈₄Si₁₂Cr₂Cu₂ | — | — | 2.374 | 2.374 | 0.000 |
| | example | | | | | | |
| 113 | Example | | 900 | Ar + H₂ (3%) + CH₄ (4%) | 1.252 | 2.032 | −0.779 |

| | | Filling rate | Magnetic properties | | μi | Pcv |
|---|---|---|---|---|---|---|
| | Example/ | of mixed | | Pcv | impovement | reduction |
| Sample | Comparative | powder | μi | at 80% | rate | rate |
| No. | example | (%) | at 80% | (kW/m³) | (%) | (%) |
| 80 | Comparative | 80 | 39 | 1260 | 100 | 100 |
| | example | | | | | |
| 81 | Example | 80 | 55 | 909 | 141 | 72 |
| 82 | Comparative | 80 | 38 | 1261 | 100 | 100 |
| | example | | | | | |
| 83 | Example | 80 | 58 | 895 | 153 | 71 |
| 84 | Comparative | 80 | 38 | 1285 | 100 | 100 |
| | example | | | | | |
| 85 | Example | 80 | 52 | 899 | 135 | 70 |
| 86 | Comparative | 80 | 39 | 1231 | 100 | 100 |
| | example | | | | | |
| 87 | Example | 80 | 59 | 948 | 150 | 77 |
| 88 | Comparative | 80 | 37 | 1243 | 100 | 100 |
| | example | | | | | |
| 89 | Example | 80 | 55 | 933 | 149 | 75 |
| 90 | Comparative | 80 | 39 | 1237 | 100 | 100 |
| | example | | | | | |
| 91 | Example | 80 | 54 | 928 | 139 | 75 |
| 92 | Comparative | 80 | 37 | 1262 | 100 | 100 |
| | example | | | | | |
| 93 | Example | 80 | 53 | 946 | 143 | 75 |
| 94 | Comparative | 80 | 38 | 1246 | 100 | 100 |
| | example | | | | | |
| 95 | Example | 80 | 58 | 910 | 152 | 73 |
| 96 | Comparative | 80 | 37 | 1277 | 100 | 100 |
| | example | | | | | |
| 97 | Example | 80 | 53 | 920 | 144 | 72 |
| 98 | Comparative | 80 | 39 | 1268 | 100 | 100 |
| | example | | | | | |
| 99 | Example | 80 | 58 | 900 | 147 | 71 |
| 100 | Comparative | 80 | 36 | 1255 | 100 | 100 |
| | example | | | | | |
| 10 | Example | 80 | 51 | 954 | 140 | 76 |
| 102 | Comparative | 80 | 39 | 1219 | 100 | 100 |
| | example | | | | | |
| 103 | Example | 80 | 53 | 853 | 137 | 70 |
| 104 | Comparative | 80 | 38 | 1261 | 100 | 100 |
| | example | | | | | |
| 105 | Example | 80 | 55 | 958 | 144 | 76 |
| 106 | Comparative | 80 | 37 | 1266 | 100 | 100 |
| | example | | | | | |
| 107 | Example | 80 | 53 | 912 | 143 | 72 |
| 108 | Comparative | 80 | 36 | 1226 | 100 | 100 |
| | example | | | | | |
| 109 | Example | 80 | 53 | 944 | 147 | 77 |
| 110 | Comparative | 80 | 39 | 1217 | 100 | 100 |
| | example | | | | | |
| 111 | Example | 80 | 59 | 974 | 150 | 80 |
| 112 | Comparative | 80 | 37 | 1225 | 100 | 100 |
| | example | | | | | |
| 113 | Example | 80 | 54 | 919 | 146 | 75 |

TABLE 6

| | | | Surface reducing treatment | | | | |
|---|---|---|---|---|---|---|---|
| | Example/ | | Heating | | FeCo Concentration in Soft magnetic particle | | |
| Sample | Comparative | | temp. | | | | σ_{FeCo} (S) − |
| No. | example | Composition | (° C.) | Atmosphere | σ_{FeCo} (S) | σ_{FeCo} (C) | σ_{FeCo} (C) |
| 54 | Comparative | (Fe_{0.9}Co_{0.1})₈₈Si₁₂ | — | — | 1.981 | 1.981 | 0.000 |
| | example | | | | | | |
| 55 | Example | | 900 | Ar + H₂ (3%) + CH₄ (4%) | 1.316 | 1.977 | −0.661 |
| 114 | Comparative | (Fe_{0.9}Co_{0.1})_{87.5}Si₁₂C_{0.5} | — | — | 2.099 | 2.102 | −0.003 |
| | example | | | | | | |
| 115 | Example | | 900 | Ar + H₂ (3%) + CH₄ (4%) | 1.558 | 2.097 | −0.539 |
| 116 | Comparative | (Fe_{0.9}Co_{0.1})₈₆Si₁₂C₂ | — | — | 2.223 | 2.221 | 0.002 |
| | example | | | | | | |
| 117 | Example | | 900 | Ar + H₂ (3%) + CH₄ (4%) | 1.498 | 2.112 | −0.614 |
| 118 | Comparative | (Fe_{0.9}Co_{0.1})_{87.5}Si₁₂Al_{0.5} | — | — | 2.097 | 2.100 | −0.003 |
| | example | | | | | | |
| 119 | Example | | 900 | Ar + H₂ (3%) + CH₄ (4%) | 1.512 | 2.034 | −0.522 |
| 120 | Comparative | (Fe_{0.9}Co_{0.1})₈₆Si₁₂Al₂ | — | — | 2.223 | 2.222 | 0.001 |
| | example | | | | | | |
| 121 | Example | | 900 | Ar + H₂ (3%) + CH₄ (4%) | 1.759 | 2.236 | −0.477 |
| 122 | Comparative | (Fe_{0.9}Co_{0.1})_{87.975}Si₁₂S_{0.025} | — | — | 2.061 | 2.060 | 0.001 |
| | example | | | | | | |
| 123 | Example | | 900 | Ar + H₂ (3%) + CH₄ (4%) | 1.402 | 2.044 | −0.642 |
| 124 | Comparative | (Fe_{0.9}Co_{0.1})_{87.9}Si₁₂S_{0.1} | — | — | 2.064 | 2.067 | −0.003 |
| | example | | | | | | |
| 125 | Example | | 900 | Ar + H₂ (3%) + CH₄ (4%) | 1.396 | 2.061 | −0.665 |
| 126 | Comparative | (Fe_{0.9}Co_{0.1})_{87.5}Si₁₂Ti_{0.5} | — | — | 2.102 | 2.102 | 0.000 |
| | example | | | | | | |
| 127 | Example | | 900 | Ar + H₂ (3%) + CH₄ (4%) | 1.401 | 1.966 | −0.565 |
| 128 | Comparative | (Fe_{0.9}Co_{0.1})₈₆Si₁₂Ti₂ | — | — | 2.226 | 2.223 | 0.003 |
| | example | | | | | | |
| 129 | Example | | 900 | Ar + H₂ (3%) + CH₄ (4%) | 1.482 | 2.190 | −0.708 |
| 130 | Comparative | (Fe_{0.9}Co_{0.1})_{87.5}Si₁₂V_{0.5} | — | — | 2.100 | 2.099 | 0.001 |
| | example | | | | | | |
| 131 | Example | | 900 | Ar + H₂ (3%) + CH₄ (4%) | 1.510 | 1.988 | −0.478 |
| 132 | Comparative | (Fe_{0.9}Co_{0.1})₈₆Si₁₂V₂ | — | — | 2.224 | 2.224 | 0.000 |
| | example | | | | | | |
| 133 | Example | | 900 | Ar + H₂ (3%) + CH₄ (4%) | 1.456 | 2.098 | −0.642 |
| 134 | Comparative | (Fe_{0.9}Co_{0.1})_{87.5}Si₁₂Mn_{0.5} | — | — | 2.102 | 2.100 | 0.002 |
| | example | | | | | | |
| 135 | Example | | 900 | Ar + H₂ (3%) + CH₄ (4%) | 1.444 | 1.865 | −0.421 |
| 136 | Comparative | (Fe_{0.9}Co_{0.1})₈₆Si₁₂Mn₂ | — | — | 2.223 | 2.223 | 0.000 |
| | example | | | | | | |
| 137 | Example | | 900 | Ar + H₂ (3%) + CH₄ (4%) | 1.489 | 1.939 | −0.450 |
| 138 | Comparative | (Fe_{0.9}Co_{0.1})_{87.5}Si₁₂Ni_{0.5} | — | — | 2.103 | 2.101 | 0.002 |
| | example | | | | | | |
| 139 | Example | | 900 | Ar + H₂ (3%) + CH₄ (4%) | 1.456 | 2.012 | −0.556 |
| 140 | Comparative | (Fe_{0.9}Co_{0.1})₈₆Si₁₂Ni₂ | — | — | 2.223 | 2.222 | 0.001 |
| | example | | | | | | |
| 141 | Example | | 900 | Ar + H₂ (3%) + CH₄ (4%) | 1.402 | 1.987 | −0.585 |
| 142 | Comparative | (Fe_{0.9}Co_{0.1})_{87.5}Si₁₂Cu_{0.5} | — | — | 2.098 | 2.099 | −0.001 |
| | example | | | | | | |
| 143 | Example | | 900 | Ar + H₂ (3%) + CH₄ (4%) | 1.497 | 2.070 | −0.573 |
| 144 | Comparative | (Fe_{0.9}Co_{0.1})₈₆Si₁₂Cu₂ | — | — | 2.227 | 2.224 | 0.003 |
| | example | | | | | | |
| 145 | Example | | 900 | Ar + H₂ (3%) + CH₄ (4%) | 1.480 | 1.940 | −0.460 |

| | | Filling rate | Magnetic properties | | μi | Pcv |
|---|---|---|---|---|---|---|
| | Example/ | of mixed | | Pcv | impovement | reduction |
| Sample | Comparative | powder | μi | at 80% | rate | rate |
| No. | example | (%) | at 80% | (kW/m³) | (%) | (%) |
| 54 | Comparative | 80 | 37 | 1389 | 100 | 100 |
| | example | | | | | |
| 55 | Example | 80 | 48 | 1102 | 130 | 79 |
| 114 | Comparative | 80 | 34 | 1398 | 100 | 100 |
| | example | | | | | |
| 115 | Example | 80 | 44 | 1139 | 128 | 82 |
| 116 | Comparative | 80 | 34 | 1394 | 100 | 100 |
| | example | | | | | |
| 117 | Example | 80 | 42 | 1161 | 125 | 83 |
| 118 | Comparative | 80 | 36 | 1438 | 100 | 100 |
| | example | | | | | |
| 119 | Example | 80 | 45 | 1127 | 126 | 78 |
| 120 | Comparative | 80 | 35 | 1443 | 100 | 100 |
| | example | | | | | |
| 121 | Example | 80 | 42 | 1167 | 12 | 81 |
| 122 | Comparative | 80 | 36 | 1411 | 100 | 100 |
| | example | | | | | |
| 123 | Example | 80 | 44 | 1076 | 123 | 76 |
| 124 | Comparative | 80 | 35 | 1447 | 100 | 100 |
| | example | | | | | |
| 125 | Example | 80 | 48 | 1196 | 137 | 83 |
| 126 | Comparative | 80 | 34 | 1437 | 100 | 100 |
| | example | | | | | |
| 127 | Example | 80 | 49 | 1102 | 146 | 77 |
| 128 | Comparative | 80 | 36 | 1417 | 100 | 100 |
| | example | | | | | |
| 129 | Example | 80 | 49 | 1082 | 138 | 76 |
| 130 | Comparative | 80 | 34 | 1443 | 100 | 100 |
| | example | | | | | |
| 131 | Example | 80 | 45 | 1180 | 133 | 82 |
| 132 | Comparative | 80 | 34 | 1439 | 100 | 100 |
| | example | | | | | |
| 133 | Example | 80 | 48 | 1082 | 140 | 75 |
| 134 | Comparative | 80 | 35 | 1416 | 100 | 100 |
| | example | | | | | |
| 135 | Example | 80 | 49 | 1087 | 139 | 77 |
| 136 | Comparative | 80 | 35 | 1420 | 100 | 100 |
| | example | | | | | |
| 137 | Example | 80 | 43 | 1063 | 123 | 75 |
| 138 | Comparative | 80 | 35 | 1400 | 100 | 100 |
| | example | | | | | |
| 139 | Example | 80 | 45 | 1163 | 127 | 83 |
| 140 | Comparative | 80 | 36 | 1381 | 100 | 100 |
| | example | | | | | |
| 141 | Example | 80 | 48 | 1072 | 135 | 78 |
| 142 | Comparative | 80 | 35 | 1448 | 100 | 100 |
| | example | | | | | |
| 143 | Example | 80 | 49 | 1104 | 141 | 76 |
| 144 | Comparative | 80 | 36 | 1453 | 100 | 100 |
| | example | | | | | |
| 145 | Example | 80 | 47 | 1075 | 131 | 74 |

TABLE 7

| | | | Surface reducing treatment | | | |
|---|---|---|---|---|---|---|
| | Example/ | | Heating | | | |
| Sample | Comparative | | Temp. | | FeCo Concentration in Soft magnetic particle | |
| No. | example | Composition | (° C.) | Atmosphere | σ_{FeCo} (S) | σ_{FeCo} (C) |
| 146 | Comparative | (Fe_{0.8}Co_{0.2})₈₂Si₂B₁₁P₄Cr₁ | — | — | 2.901 | 2.902 |
| | example | | | | | |
| 147 | Example | | 380 | Ar + H₂ (3%) + CH₄ (4%) | 2.557 | 2.892 |
| 148 | Comparative | (Fe_{0.70}Co_{0.3})_{83.5}Si_{0.50}C_{0.5}B_{11.5}P₄ | — | — | 2.891 | 2.890 |
| | example | | | | | |
| 149 | Example | | 380 | Ar + H₂ (3%) + CH₄ (4%) | 2.463 | 2.835 |
| 150 | Comparative | Fe₇₅Si₁₀B₁₅ | — | — | 2.998 | 2.999 |
| | example | | | | | |
| 151 | Example | | 400 | Ar + H₂ (3%) + CH₄ (4%) | 2.489 | 2.837 |
| 152 | Comparative | Fe₇₆Si₁₁C₂B₁₁ | — | — | 2.983 | 2.981 |
| | example | | | | | |
| 153 | Example | | 400 | Ar + H₂ (3%) + CH₄ (4%) | 2.573 | 2.901 |
| 154 | Comparative | Fe₇₅Si₁₁C₂B₁₁Cr₁ | — | — | 2.967 | 2.969 |
| | example | | | | | |
| 155 | Example | | 400 | Ar + H₂ (3%) + CH₄ (4%) | 2.523 | 2.863 |
| 156 | Comparative | (Fe_{0.8}Co_{0.2})₈₀C₅P₁₅ | — | — | 2.907 | 2.907 |
| | example | | | | | |
| 157 | Example | | 380 | Ar + H₂ (3%) + CH₄ (4%) | 2.560 | 2.900 |
| 158 | Comparative | (Fe_{0.75}Co_{0.25})₈₀B₂₀ | — | — | 2.878 | 2.877 |
| | example | | | | | |
| 159 | Example | | 380 | Ar + H₂ (3%) + CH₄ (4%) | 2.508 | 2.902 |
| 160 | Comparative | (Fe_{0.8}Co_{0.2})₇₅Si₁₀B₁₅ | — | — | 2.876 | 2.876 |
| | example | | | | | |
| 161 | Example | | 400 | Ar + H₂ (3%) + CH₄ (4%) | 2.512 | 2.835 |
| 162 | Comparative | Fe₇₃Si₁₄B₉Nb₃Cu₁ | — | — | 6.845 | 6.844 |
| | example | | | | | |
| 163 | Example | | 550 | Ar + H₂ (3%) + CH₄ (4%) | 6.044 | 6.812 |
| 164 | Comparative | Fe₇₈Si₂B₉P₄Nb₇ | — | — | 6.763 | 6.762 |
| | example | | | | | |
| 165 | Example | | 600 | Ar + H₂ (3%) + CH₄ (4%) | 5.664 | 6.760 |
| 166 | Comparative | (Fe_{0.75}Co_{0.25})₇₉B₉P₁Nb₈Mo₃ | — | — | 6.701 | 6.699 |
| | example | | | | | |
| 167 | Example | | 600 | Ar + H₂ (3%) + CH₄ (4%) | 5.797 | 6.701 |
| 168 | Comparative | Fe_{0.75}Co_{0.25})₇₉B₁₀P₃Zr₃Nb₅ | — | — | 6.780 | 6.781 |
| | example | | | | | |
| 169 | Example | | 550 | Ar + H₂ (3%) + CH₄ (4%) | 5.802 | 6.772 |
| 170 | Comparative | (Fe_{0.75}Co_{0.25})₈₂B₈P₁Zr₈Mo₁ | — | — | 6.701 | 6.700 |
| | example | | | | | |
| 171 | Example | | 550 | Ar + H₂ (3%) + CH₄ (4%) | 5.791 | 6.689 |

| | | | Filling rate | Magnetic properties | | μi | Pcv |
|---|---|---|---|---|---|---|---|
| | Example/ | FeCo Concentration in Soft magnetic particle | of mixed | | Pcv | impovement | reduction |
| Sample | Comparative | σ_{FeCo} (S) − | powder | μi | at 80% | rate | rate |
| No. | example | σ_{FeCo} (C) | (%) | at 80% | (kW/m³) | (%) | (%) |
| 146 | Comparative | −0.001 | 80 | 33 | 1104 | 100 | 100 |
| | example | | | | | | |
| 147 | Example | −0.335 | 80 | 43 | 801 | 130 | 73 |
| 148 | Comparative | 0.001 | 80 | 32 | 1119 | 100 | 100 |
| | example | | | | | | |
| 149 | Example | −0.372 | 80 | 44 | 861 | 138 | 77 |
| 150 | Comparative | −0.001 | 80 | 34 | 1165 | 100 | 100 |
| | example | | | | | | |
| 151 | Example | −0.348 | 80 | 45 | 831 | 132 | 71 |
| 152 | Comparative | 0.002 | 80 | 33 | 1078 | 100 | 100 |
| | example | | | | | | |
| 153 | Example | −0.328 | 80 | 44 | 789 | 133 | 73 |
| 154 | Comparative | −0.002 | 80 | 33 | 1082 | 100 | 100 |
| | example | | | | | | |
| 155 | Example | −0.340 | 80 | 46 | 836 | 139 | 77 |
| 156 | Comparative | 0.000 | 80 | 32 | 1085 | 100 | 100 |
| | example | | | | | | |
| 157 | Example | −0.340 | 80 | 45 | 837 | 141 | 77 |
| 158 | Comparative | 0.001 | 80 | 33 | 1162 | 100 | 100 |
| | example | | | | | | |
| 159 | Example | −0.394 | 80 | 47 | 901 | 142 | 78 |
| 160 | Comparative | 0.000 | 80 | 32 | 1099 | 100 | 100 |
| | example | | | | | | |
| 161 | Example | −0.323 | 80 | 47 | 841 | 147 | 77 |
| 162 | Comparative | 0.001 | 80 | 33 | 796 | 100 | 100 |
| | example | | | | | | |
| 163 | Example | −0.768 | 80 | 45 | 648 | 136 | 81 |
| 164 | Comparative | 0.001 | 80 | 33 | 771 | 100 | 100 |
| | example | | | | | | |
| 165 | Example | −1.096 | 80 | 46 | 609 | 139 | 79 |
| 166 | Comparative | 0.002 | 80 | 32 | 901 | 100 | 100 |
| | example | | | | | | |
| 167 | Example | −0.904 | 80 | 44 | 681 | 138 | 76 |
| 168 | Comparative | −0.001 | 80 | 33 | 934 | 100 | 100 |
| | example | | | | | | |
| 169 | Example | −0.970 | 80 | 46 | 701 | 139 | 75 |
| 170 | Comparative | 0.001 | 80 | 33 | 1001 | 100 | 100 |
| | example | | | | | | |
| 171 | Example | −0.898 | 80 | 47 | 773 | 142 | 77 |

TABLE 8

| | | | Surface reducing treatment | | | |
|---|---|---|---|---|---|---|
| | Example/ | | Heating | | | |
| Sample | Comparative | | Temp. | | FeCo Concentration in Soft magnetic particle | |
| No. | example | Composition | (° C.) | Atmosphere | σ_{FeCo} (S) | σ_{FeCo} (C) |
| 172 | Comparative | (Fe_{0.70}Co_{0.30})_{69.00}B_{6.50}P_{14.50}Si_{9.00}Cr_{1.00} | — | — | 2.941 | 2.943 |
| | example | | | | | |
| 173 | Example | | 380 | Ar + H₂ (3%) + CH₄ (4%) | 2.550 | 2.995 |
| 174 | Comparative | (Fe_{0.70}Co_{0.30})_{79.00}B_{10.00}P_{6.00}Si_{4.00}Cr_{1.00} | — | — | 2.985 | 2.983 |
| | example | | | | | |
| 175 | Example | | 380 | Ar + H₂ (3%) + CH₄ (4%) | 2.484 | 3.037 |
| 176 | Comparative | (Fe_{0.70}Co_{0.30})_{82.00}B_{11.00}P_{3.00}Si_{3.00}Cr_{1.00} | — | — | 2.968 | 2.967 |
| | example | | | | | |
| 177 | Example | | 380 | Ar + H₂ (3%) + CH₄ (4%) | 2.557 | 3.199 |
| 178 | Comparative | (Fe_{0.70}Co_{0.30})_{85.00}B_{9.00}P_{3.00}Si_{2.50}Cr_{0.50} | — | — | 2.970 | 2.968 |
| | example | | | | | |
| 179 | Example | | 380 | Ar + H₂ (3%) + CH₄ (4%) | 2.468 | 2.899 |
| 180 | Comparative | Fe_{83.50}B_{10.00}P_{5.00}Si_{0.50}Cr_{1.00} | — | — | 2.911 | 2.909 |
| | example | | | | | |
| 181 | Example | | 380 | Ar + H₂ (3%) + CH₄ (4%) | 2.514 | 2.883 |
| 182 | Comparative | (Fe_{0.90}Co_{0.10})_{83.50}B_{10.00}P_{5.00}Si_{0.50}Cr_{1.00} | — | — | 2.916 | 2.918 |
| | example | | | | | |
| 183 | Example | | 380 | Ar + H₂ (3%) + CH₄ (4%) | 2.496 | 2.877 |
| 184 | Comparative | (Fe_{0.60}Co_{0.40})_{83.50}B_{10.00}P_{5.00}Si_{0.50}Cr_{1.00} | — | — | 2.949 | 2.948 |
| | example | | | | | |
| 185 | Example | | 380 | Ar + H₂ (3%) + CH₄ (4%) | 2.559 | 2.999 |
| 186 | Comparative | (Fe_{0.40}Co_{0.60})_{83.50}B_{10.00}P_{5.00}Si_{0.50}Cr_{1.00} | — | — | 2.939 | 2.938 |
| | example | | | | | |
| 187 | Example | | 380 | Ar + H₂ (3%) + CH₄ (4%) | 2.572 | 3.096 |
| 188 | Comparative | Fe_{75.15}B_{10.00}P_{5.00}Si_{0.50}Cr_{1.00}Ni_{8.35} | — | — | 2.999 | 3.001 |
| | example | | | | | |
| 189 | Example | | 380 | Ar + H₂ (3%) + CH₄ (4%) | 2.566 | 3.014 |
| 190 | Comparative | Fe_{33.4}B_{10.00}P_{5.00}Si_{0.50}Cr_{1.00}Ni_{50.1} | — | — | 2.926 | 2.925 |
| | example | | | | | |
| 191 | Example | | 380 | Ar + H₂ (3%) + CH₄ (4%) | 2.497 | 3.071 |
| 192 | Comparative | Fe₂₀Ni₈₀ | — | — | 2.982 | 2.983 |
| | example | | | | | |
| 193 | Example | | 380 | Ar + H₂ (3%) + CH₄ (4%) | 2.465 | 2.878 |
| 194 | Comparative | Fe_{83.00}B_{11.80}P_{2.00}Cr_{3.20} | — | — | 2.993 | 2.994 |
| | example | | | | | |
| 195 | Example | | 380 | Ar + H₂ (3%) + CH₄ (4%) | 2.534 | 2.908 |
| 196 | Comparative | Fe_{83.00}B_{11.10}P_{3.00}C_{0.50}Cr_{2.40} | — | — | 2.958 | 2.959 |
| | example | | | | | |
| 197 | Example | | 380 | Ar + H₂ (3%) + CH₄ (4%) | 2.520 | 3.034 |
| 198 | Comparative | Fe_{83.00}B_{10.00}C_{5.00}Cr_{2.00} | — | — | 2.962 | 2.962 |
| | example | | | | | |
| 199 | Example | | 380 | Ar + H₂ (3%) + CH₄ (4%) | 2.482 | 2.969 |
| 200 | Comparative | Fe_{74.50}B_{20.50}Si_{3.40}C_{1.60} | — | — | 2.958 | 2.956 |
| | example | | | | | |
| 201 | Example | | 380 | Ar + H₂ (3%) + CH₄ (4%) | 2.476 | 3.067 |
| 202 | Comparative | Fe_{82.00}B_{5.00}P_{5.00}Si_{7.00}Cu_{1.00} | — | — | 2.932 | 2.933 |
| | example | | | | | |
| 203 | Example | | 380 | Ar + H₂ (3%) + CH₄ (4%) | 2.512 | 2.964 |
| 204 | Comparative | (Fe_{0.70}Co_{0.30})_{83.45}B_{12.00}P_{4.00}Si_{0.50}Cu_{0.05} | — | — | 3.000 | 3.001 |
| | example | | | | | |
| 205 | Example | | 380 | Ar + H₂ (3%) + CH₄ (4%) | 2.498 | 2.903 |
| 206 | Comparative | (Fe_{0.70}Co_{0.30})_{79.50}B_{12.00}P_{4.00}Si_{0.50}Cu_{4.00} | — | — | 2.999 | 3.001 |
| | example | | | | | |
| 207 | Example | | 380 | Ar + H₂ (3%) + CH₄ (4%) | 2.498 | 3.025 |
| 208 | Comparative | (Fe_{0.70}Co_{0.30})_{83.45}B_{12.00}P_{4.00}Si_{0.50}Al_{0.05} | — | — | 2.907 | 2.906 |
| | example | | | | | |
| 209 | Example | | 380 | Ar + H₂ (3%) + CH₄ (4%) | 2.570 | 3.214 |
| 210 | Comparative | (Fe_{0.70}Co_{0.30})_{79.50}B_{12.00}P_{4.00}Si_{0.50}Al_{4.00} | — | — | 2.956 | 2.954 |
| | example | | | | | |
| 211 | Example | | 380 | Ar + H₂ (3%) + CH₄ (4%) | 2.568 | 2.975 |
| 212 | Comparative | (Fe_{0.70}Co_{0.30})_{82.50}B_{12.00}P_{4.00}Si_{0.50}Ti_{1.00} | — | — | 2.875 | 2.873 |
| | example | | | | | |
| 213 | Example | | 380 | Ar + H₂ (3%) + CH₄ (4%) | 2.481 | 3.079 |

| | | | Filling rate | Magnetic properties | | μi | Pcv |
|---|---|---|---|---|---|---|---|
| | Example/ | FeCo Concentration in Soft magnetic particle | of mixed | | Pcv | impovement | reduction |
| Sample | Comparative | σ_{FeCo} (S) − | powder | μi | at 80% | rate | rate |
| No. | example | σ_{FeCo} (C) | (%) | at 80% | (kW/m³) | (%) | (%) |
| 172 | Comparative | −0.002 | 80 | 34 | 1097 | 100 | 100 |
| | example | | | | | | |
| 173 | Example | −0.445 | 80 | 45 | 834 | 132 | 76 |
| 174 | Comparative | 0.002 | 80 | 34 | 1087 | 100 | 100 |
| | example | | | | | | |
| 175 | Example | −0.553 | 80 | 44 | 794 | 130 | 73 |
| 176 | Comparative | 0.001 | 80 | 32 | 1150 | 100 | 100 |
| | example | | | | | | |
| 177 | Example | −0.642 | 80 | 40 | 817 | 125 | 71 |
| 178 | Comparative | 0.002 | 80 | 32 | 1094 | 100 | 100 |
| | example | | | | | | |
| 179 | Example | −0.431 | 80 | 42 | 788 | 130 | 72 |
| 180 | Comparative | 0.002 | 80 | 31 | 1138 | 100 | 100 |
| | example | | | | | | |
| 181 | Example | −0.369 | 80 | 39 | 865 | 126 | 76 |
| 182 | Comparative | −0.002 | 80 | 34 | 1166 | 100 | 100 |
| | example | | | | | | |
| 183 | Example | −0.381 | 80 | 51 | 956 | 150 | 82 |
| 184 | Comparative | 0.001 | 80 | 34 | 1130 | 100 | 100 |
| | example | | | | | | |
| 185 | Example | −0.440 | 80 | 48 | 836 | 142 | 74 |
| 186 | Comparative | 0.001 | 80 | 34 | 1141 | 100 | 100 |
| | example | | | | | | |
| 187 | Example | −0.524 | 80 | 42 | 970 | 124 | 85 |
| 188 | Comparative | −0.002 | 80 | 32 | 1161 | 100 | 100 |
| | example | | | | | | |
| 189 | Example | −0.448 | 80 | 39 | 964 | 122 | 83 |
| 190 | Comparative | 0.001 | 80 | 33 | 1127 | 100 | 100 |
| | example | | | | | | |
| 191 | Example | −0.574 | 80 | 50 | 902 | 150 | 80 |
| 192 | Comparative | −0.001 | 80 | 35 | 1081 | 100 | 100 |
| | example | | | | | | |
| 193 | Example | −0.413 | 80 | 46 | 876 | 131 | 81 |
| 194 | Comparative | −0.001 | 80 | 35 | 1106 | 100 | 100 |
| | example | | | | | | |
| 195 | Example | −0.374 | 80 | 51 | 830 | 147 | 75 |
| 196 | Comparative | −0.001 | 80 | 33 | 1170 | 100 | 100 |
| | example | | | | | | |
| 197 | Example | −0.514 | 80 | 44 | 842 | 132 | 72 |
| 198 | Comparative | 0.000 | 80 | 33 | 1164 | 100 | 100 |
| | example | | | | | | |
| 199 | Example | −0.487 | 80 | 46 | 943 | 140 | 81 |
| 200 | Comparative | 0.002 | 80 | 35 | 1111 | 100 | 100 |
| | example | | | | | | |
| 201 | Example | −0.591 | 80 | 47 | 944 | 133 | 85 |
| 202 | Comparative | −0.001 | 80 | 32 | 1094 | 100 | 100 |
| | example | | | | | | |
| 203 | Example | −0.452 | 80 | 39 | 853 | 122 | 78 |
| 204 | Comparative | −0.001 | 80 | 32 | 1111 | 100 | 100 |
| | example | | | | | | |
| 205 | Example | −0.405 | 80 | 45 | 811 | 140 | 73 |
| 206 | Comparative | −0.002 | 80 | 31 | 1128 | 100 | 100 |
| | example | | | | | | |
| 207 | Example | −0.527 | 80 | 42 | 914 | 134 | 81 |
| 208 | Comparative | 0.001 | 80 | 35 | 1099 | 100 | 100 |
| | example | | | | | | |
| 209 | Example | −0.644 | 80 | 53 | 846 | 150 | 77 |
| 210 | Comparative | 0.002 | 80 | 33 | 1140 | 100 | 100 |
| | example | | | | | | |
| 211 | Example | −0.407 | 80 | 49 | 935 | 147 | 82 |
| 212 | Comparative | 0.002 | 80 | 35 | 1133 | 100 | 100 |
| | example | | | | | | |
| 213 | Example | −0.598 | 80 | 47 | 952 | 134 | 84 |

TABLE 9

| | | | Surface reducing treatment | | | |
|---|---|---|---|---|---|---|
| | Example/ | | Heating | | | |
| Sample | Comparative | | Temp. | | FeCo Concentration in Soft magnetic particle | |
| No. | example | Composition | ° C. | Atmosphere | σ_{FeCo} (S) | σ_{FeCo} (C) |
| 214 | Comparative | (Fe_{0.70}Co_{0.30})_{82.50}B_{12.00}P_{4.00}Si_{0.50}V_{1.00} | — | — | 2.997 | 2.997 |
| | example | | | | | |
| 215 | Example | | 380 | Ar + H₂ (3%) + CH₄ (4%) | 2.495 | 2.864 |
| 216 | Comparative | (Fe_{0.70}Co_{0.30})_{82.50}B_{12.00}P_{4.00}Si_{0.50}Mn_{1.00} | — | — | 2.940 | 2.939 |
| | example | | | | | |
| 217 | Example | | 380 | Ar + H₂ (3%) + CH₄ (4%) | 2.543 | 3.008 |
| 218 | Comparative | (Fe_{0.70}Co_{0.30})_{82.50}B_{12.00}P_{4.00}Si_{0.50}Zn_{1.00} | — | — | 2.931 | 2.933 |
| | example | | | | | |
| 219 | Example | | 380 | Ar + H₂ (3%) + CH₄ (4%) | 2.468 | 3.066 |
| 220 | Comparative | (Fe_{0.70}Co_{0.30})_{82.50}B_{12.00}P_{4.00}Si_{0.50}Ga_{1.00} | — | — | 2.880 | 2.878 |
| | example | | | | | |
| 221 | Example | | 380 | Ar + H₂ (3%) + CH₄ (4%) | 2.473 | 2.992 |
| 222 | Comparative | (Fe_{0.70}Co_{0.30})_{82.50}B_{12.00}P_{4.00}Si_{0.50}As_{1.00} | — | — | 2.887 | 2.887 |
| | example | | | | | |
| 223 | Example | | 380 | Ar + H₂ (3%) + CH₄ (4%) | 2.534 | 2.986 |
| 224 | Comparative | (Fe_{0.70}Co_{0.30})_{82.50}B_{12.00}P_{4.00}Si_{0.50}Ag_{1.00} | — | — | 2.908 | 2.910 |
| | example | | | | | |
| 225 | Example | | 380 | Ar + H₂ (3%) + CH₄ (4%) | 2.511 | 3.106 |
| 226 | Comparative | (Fe_{0.70}Co_{0.30})_{82.50}B_{12.00}P_{4.00}Si_{0.50}Sn_{1.00} | — | — | 2.991 | 2.992 |
| | example | | | | | |
| 227 | Example | | 380 | Ar + H₂ (3%) + CH₄ (4%) | 2.557 | 2.980 |
| 228 | Comparative | (Fe_{0.70}Co_{0.30})_{82.50}B_{12.00}P_{4.00}Si_{0.50}Sb_{1.00} | — | — | 2.950 | 2.951 |
| | example | | | | | |
| 229 | Example | | 380 | Ar + H₂ (3%) + CH₄ (4%) | 2.500 | 2.918 |
| 230 | Comparative | (Fe_{0.70}Co_{0.30})_{82.50}B_{12.00}P_{4.00}Si_{0.50}Au_{1.00} | — | — | 2.915 | 2.915 |
| | example | | | | | |
| 231 | Example | | 380 | Ar + H₂ (3%) + CH₄ (4%) | 2.504 | 2.921 |
| 232 | Comparative | (Fe_{0.70}Co_{0.30})_{82.50}B_{12.00}P_{4.00}Si_{0.50}Bi_{1.00} | — | — | 2.899 | 2.898 |
| | example | | | | | |
| 233 | Example | | 380 | Ar + H₂ (3%) + CH₄ (4%) | 2.470 | 3.053 |
| 234 | Comparative | (Fe_{0.70}Co_{0.30})_{82.50}B_{12.00}P_{4.00}Si_{0.50}Y_{1.00} | — | — | 2.964 | 2.964 |
| | example | | | | | |
| 235 | Example | | 380 | Ar + H₂ (3%) + CH₄ (4%) | 2.471 | 2.830 |
| 236 | Comparative | (Fe_{0.70}Co_{0.30})_{82.50}B_{12.00}P_{4.00}Si_{0.50}La_{1.00} | — | — | 2.939 | 2.937 |
| | example | | | | | |
| 237 | Example | | 380 | Ar + H₂ (3%) + CH₄ (4%) | 2.550 | 3.130 |
| 238 | Comparative | (Fe_{0.70}Co_{0.30})_{82.50}B_{12.00}P_{4.00}Si_{0.50}Pt_{1.00} | — | — | 2.893 | 2.894 |
| | example | | | | | |
| 239 | Example | | 380 | Ar + H₂ (3%) + CH₄ (4%) | 2.580 | 3.141 |
| 240 | Comparative | (Fe_{0.70}Co_{0.30})_{83.45}B_{12.00}P_{4.00}Si_{0.50}S_{0.05} | — | — | 2.942 | 2.941 |
| | example | | | | | |
| 241 | Example | | 380 | Ar + H₂ (3%) + CH₄ (4%) | 2.496 | 3.005 |
| 242 | Comparative | (Fe_{0.70}Co_{0.30})_{82.50}B_{12.00}P_{4.00}Si_{0.50}S_{1.00} | — | — | 2.902 | 2.901 |
| | example | | | | | |
| 243 | Example | | 380 | Ar + H₂ (3%) + CH₄ (4%) | 2.574 | 3.147 |
| 244 | Comparative | (Fe_{0.70}Co_{0.30})_{83.40}B_{12.00}P_{4.00}Si_{0.50}Mg_{0.10} | — | — | 2.923 | 2.925 |
| | example | | | | | |
| 245 | Example | | 380 | Ar + H₂ (3%) + CH₄ (4%) | 2.563 | 3.088 |
| 246 | Comparative | (Fe_{0.70}Co_{0.30})_{83.40}B_{12.00}P_{4.00}Si_{0.50}Ca_{0.10} | — | — | 2.904 | 2.906 |
| | example | | | | | |
| 247 | Example | | 380 | Ar + H₂ (3%) + CH₄ (4%) | 2.550 | 3.160 |
| 248 | Comparative | (Fe_{0.70}Co_{0.30})_{83.49}B_{12.00}P_{4.00}Si_{0.50}N_{0.01} | — | — | 2.879 | 2.878 |
| | example | | | | | |
| 249 | Example | | 380 | Ar + H₂ (3%) + CH₄ (4%) | 2.570 | 3.034 |
| 250 | Comparative | (Fe_{0.70}Co_{0.30})_{83.40}B_{12.00}P_{4.00}Si_{0.50}N_{0.10} | — | — | 2.962 | 2.963 |
| | example | | | | | |
| 251 | Example | | 380 | Ar + H₂ (3%) + CH₄ (4%) | 2.511 | 2.873 |
| 252 | Comparative | (Fe_{0.70}Co_{0.30})_{83.40}B_{12.00}P_{4.00}Si_{0.50}O_{0.10} | — | — | 2.943 | 2.943 |
| | example | | | | | |
| 253 | Example | | 380 | Ar + H₂ (3%) + CH₄ (4%) | 2.543 | 3.020 |
| 254 | Comparative | (Fe_{0.70}Co_{0.30})_{80.50}B_{12.00}P_{4.00}Si_{0.50}O_{3.00} | — | — | 2.949 | 2.951 |
| | example | | | | | |
| 255 | Example | | 380 | Ar + H₂ (3%) + CH₄ (4%) | 2.530 | 3.072 |
| 256 | Comparative | (Fe_{0.70}Co_{0.30})_{82.50}B_{12.00}P_{4.00}Si_{0.50}Zr_{1.00} | — | — | 2.913 | 2.913 |
| | example | | | | | |
| 257 | Example | | 380 | Ar + H₂ (3%) + CH₄ (4%) | 2.484 | 2.975 |

| | | | Filling rate | Magnetic properties | | μi | Pcv |
|---|---|---|---|---|---|---|---|
| | Example/ | FeCo Concentration in Soft magnetic particle | of mixed | | Pcv | impovement | reduction |
| Sample | Comparative | σ_{FeCo} (S) − | powder | μi | at 80% | rate | rate |
| No. | example | σ_{FeCo} (C) | (%) | at 80% | (kW/m³) | (%) | (%) |
| 214 | Comparative | 0.000 | 80 | 35 | 1169 | 100 | 100 |
| | example | | | | | | |
| 215 | Example | −0.369 | 80 | 46 | 924 | 130 | 79 |
| 216 | Comparative | 0.001 | 80 | 33 | 1150 | 100 | 100 |
| | example | | | | | | |
| 217 | Example | −0.465 | 80 | 47 | 851 | 142 | 74 |
| 218 | Comparative | −0.002 | 80 | 31 | 1142 | 100 | 100 |
| | example | | | | | | |
| 219 | Example | −0.598 | 80 | 39 | 879 | 127 | 77 |
| 220 | Comparative | 0.002 | 80 | 34 | 1115 | 100 | 100 |
| | example | | | | | | |
| 221 | Example | −0.519 | 80 | 51 | 814 | 149 | 73 |
| 222 | Comparative | 0.000 | 80 | 31 | 1119 | 100 | 100 |
| | example | | | | | | |
| 223 | Example | −0.452 | 80 | 39 | 806 | 125 | 72 |
| 224 | Comparative | −0.002 | 80 | 31 | 1136 | 100 | 100 |
| | example | | | | | | |
| 225 | Example | −0.595 | 80 | 45 | 807 | 146 | 71 |
| 226 | Comparative | −0.001 | 80 | 32 | 1166 | 100 | 100 |
| | example | | | | | | |
| 227 | Example | −0.423 | 80 | 43 | 968 | 134 | 83 |
| 228 | Comparative | −0.001 | 80 | 34 | 1102 | 100 | 100 |
| | example | | | | | | |
| 229 | Example | −0.418 | 80 | 48 | 793 | 142 | 72 |
| 230 | Comparative | 0.000 | 80 | 31 | 1096 | 100 | 100 |
| | example | | | | | | |
| 231 | Example | −0.417 | 80 | 39 | 811 | 126 | 74 |
| 232 | Comparative | 0.001 | 80 | 33 | 1097 | 100 | 100 |
| | example | | | | | | |
| 233 | Example | −0.583 | 80 | 40 | 779 | 122 | 71 |
| 234 | Comparative | 0.000 | 80 | 32 | 1100 | 100 | 100 |
| | example | | | | | | |
| 235 | Example | −0.359 | 80 | 41 | 803 | 127 | 73 |
| 236 | Comparative | 0.002 | 80 | 32 | 1094 | 100 | 100 |
| | example | | | | | | |
| 237 | Example | −0.580 | 80 | 44 | 853 | 139 | 78 |
| 238 | Comparative | −0.001 | 80 | 33 | 1163 | 100 | 100 |
| | example | | | | | | |
| 239 | Example | −0.561 | 80 | 41 | 837 | 124 | 72 |
| 240 | Comparative | 0.001 | 80 | 32 | 1084 | 100 | 100 |
| | example | | | | | | |
| 241 | Example | −0.509 | 80 | 48 | 846 | 149 | 78 |
| 242 | Comparative | 0.001 | 80 | 31 | 1106 | 100 | 100 |
| | example | | | | | | |
| 243 | Example | −0.573 | 80 | 38 | 852 | 121 | 77 |
| 244 | Comparative | −0.002 | 80 | 33 | 1101 | 100 | 100 |
| | example | | | | | | |
| 245 | Example | −0.525 | 80 | 44 | 771 | 134 | 70 |
| 246 | Comparative | −0.002 | 80 | 34 | 1153 | 100 | 100 |
| | example | | | | | | |
| 247 | Example | −0.610 | 80 | 45 | 911 | 131 | 79 |
| 248 | Comparative | 0.001 | 80 | 31 | 1156 | 100 | 100 |
| | example | | | | | | |
| 249 | Example | −0.464 | 80 | 42 | 983 | 136 | 85 |
| 250 | Comparative | −0.001 | 80 | 35 | 1139 | 100 | 100 |
| | example | | | | | | |
| 251 | Example | −0.362 | 80 | 51 | 945 | 146 | 83 |
| 252 | Comparative | 0.000 | 80 | 31 | 1123 | 100 | 100 |
| | example | | | | | | |
| 253 | Example | −0.477 | 80 | 44 | 809 | 142 | 72 |
| 254 | Comparative | −0.002 | 80 | 31 | 1106 | 100 | 100 |
| | example | | | | | | |
| 255 | Example | −0.542 | 80 | 41 | 907 | 131 | 82 |
| 256 | Comparative | 0.000 | 80 | 32 | 1097 | 100 | 100 |
| | example | | | | | | |
| 257 | Example | −0.491 | 80 | 44 | 845 | 136 | 77 |

TABLE 10

| | | | Surface reducing treatment | |
|---|---|---|---|---|
| Sam- | Example/ | | Heating | |
| ple | Comparative | | Temp. | |
| No. | example | Composition | ° C. | Atmosphere |
| 258 | Comparative | (Fe_{0.70}Co_{0.30})_{82.50}B_{12.00}P_{4.00}Si_{0.50}Nb_{1.00} | — | — |
| | example | | | |
| 259 | Example | | 380 | Ar + H₂ (3%) + CH₄ (4%) |
| 260 | Comparative | (Fe_{0.70}Co_{0.30})_{82.50}B_{12.00}P_{4.00}Si_{0.50}Mo_{1.00} | — | — |
| | example | | | |
| 261 | Example | | 380 | Ar + H₂ (3%) + CH₄ (4%) |
| 262 | Comparative | (Fe_{0.70}Co_{0.30})_{82.50}B_{12.00}P_{4.00}Si_{0.50}Hf_{1.00} | — | — |
| | example | | | |
| 263 | Example | | 380 | Ar + H₂ (3%) + CH₄ (4%) |
| 264 | Comparative | (Fe_{0.70}Co_{0.30})_{82.50}B_{12.00}P_{4.00}Si_{0.50}Ta_{1.00} | — | — |
| | example | | | |
| 265 | Example | | 380 | Ar + H₂ (3%) + CH₄ (4%) |
| 266 | Comparative | (Fe_{0.70}Co_{0.30})_{82.50}B_{12.00}P_{4.00}Si_{0.50}W_{1.00} | — | — |
| | example | | | |
| 267 | Example | | 380 | Ar + H₂ (3%) + CH₄ (4%) |
| 268 | Comparative | (Fe_{0.70}Co_{0.30})_{69.00}B_{12.00}P_{4.00}Si_{2.00}C_{2.00}Cr_{2.00}Nb_{9.00} | — | — |
| | example | | | |
| 269 | Example | | 600 | Ar + H₂ (3%) + CH₄ (4%) |
| 270 | Comparative | (Fe_{0.70}Co_{0.30})_{79.00}B_{9.00}P_{3.00}Si_{1.00}Cr_{1.00}Nb_{7.00} | — | — |
| | example | | | |
| 271 | Example | | 600 | Ar + H₂ (3%) + CH₄ (4%) |
| 272 | Comparative | (Fe_{0.70}Co_{0.30})_{82.00}B_{9.00}P_{2.00}Nb_{7.00} | — | — |
| | example | | | |
| 273 | Example | | 600 | Ar + H₂ (3%) + CH₄ (4%) |
| 274 | Comparative | (Fe_{0.70}Co_{0.30})_{85.00}B_{8.00}P_{1.00}Nb_{6.00} | — | — |
| | example | | | |
| 275 | Example | | 600 | Ar + H₂ (3%) + CH₄ (4%) |
| 276 | Comparative | Fe_{81.00}B_{9.00}P_{3.00}Nb_{7.00} | — | — |
| | example | | | |
| 277 | Example | | 600 | Ar + H₂ (3%) + CH₄ (4%) |
| 278 | Comparative | (Fe_{0.90}Co_{0.10})_{81.00}B_{9.00}P_{3.00}Nb_{7.00} | — | — |
| | example | | | |
| 279 | Example | | 600 | Ar + H₂ (3%) + CH₄ (4%) |
| 280 | Comparative | (Fe_{0.60}Co_{0.40})_{81.00}B_{9.00}P_{3.00}Nb_{7.00} | — | — |
| | example | | | |
| 281 | Example | | 600 | Ar + H₂ (3%) + CH₄ (4%) |
| 282 | Comparative | (Fe_{0.40}Co_{0.60})_{81.00}B_{9.00}P_{3.00}Nb_{7.00} | — | — |
| | example | | | |
| 283 | Example | | 600 | Ar + H₂ (3%) + CH₄ (4%) |
| 284 | Comparative | Fe_{72.9}B_{9.00}P_{3.00}Nb_{7.00}Ni_{8.10} | — | — |
| | example | | | |
| 285 | Example | | 600 | Ar + H₂ (3%) + CH₄ (4%) |
| 286 | Comparative | (Fe_{0.57}Co_{0.43})_{56.7}B_{9.00}P_{3.00}Nb_{7.00}Ni_{24.30} | — | — |
| | example | | | |
| 287 | Example | | 600 | Ar + H₂ (3%) + CH₄ (4%) |
| 288 | Comparative | Fe_{77.80}B_{9.00}P_{3.00}Cr_{3.20}Nb_{7.00} | — | — |
| | example | | | |
| 289 | Example | | 600 | Ar + H₂ (3%) + CH₄ (4%) |
| 290 | Comparative | Fe_{80.50}B_{9.00}P_{3.00}C_{0.50}Nb_{7.00} | — | — |
| | example | | | |
| 291 | Example | | 600 | Ar + H₂ (3%) + CH₄ (4%) |
| 292 | Comparative | Fe_{79.00}B_{10.00}C_{5.00}Nb_{6.00} | — | — |
| | example | | | |
| 293 | Example | | 600 | Ar + H₂ (3%) + CH₄ (4%) |
| 294 | Comparative | Fe_{73.50}B_{20.50}Nb_{6.00} | — | — |
| | example | | | |
| 295 | Example | | 600 | Ar + H₂ (3%) + CH₄ (4%) |
| 296 | Comparative | Fe_{82.00}B_{5.00}P_{4.00}Nb_{9.00} | — | — |
| | example | | | |
| 297 | Example | | 600 | Ar + H₂ (3%) + CH₄ (4%) |
| 298 | Comparative | Fe_{73.50}B_{9.00}Si_{11.50}Cu_{1.00}Nb_{5.00} | — | — |
| | example | | | |
| 299 | Example | | 550 | Ar + H₂ (3%) + CH₄ (4%) |

| | | | | | Filling | | | μi | Pcv |
|---|---|---|---|---|---|---|---|---|---|
| | | FeCo Concentration in | | | rate of | Magnetic properties | | impove- | reduc- |
| Sam- | Example/ | Soft magnetic particle | | | mixed | | Pcv | ment | tion |
| ple | Comparative | | | σ_{FeCo} (S) − | powder | μi | at 80% | rate | rate |
| No. | example | σ_{FeCo} (S) | σ_{FeCo} (C) | σ_{FeCo} (C) | (%) | at 80% | (kW/m³) | (%) | (%) |
| 258 | Comparative | 2.892 | 2.891 | 0.001 | 80 | 34 | 1085 | 100 | 100 |
| | example | | | | | | | | |
| 259 | Example | 2.577 | 3.175 | −0.598 | 80 | 41 | 890 | 121 | 82 |
| 260 | Comparative | 2.956 | 2.957 | −0.001 | 80 | 32 | 1122 | 100 | 100 |
| | example | | | | | | | | |
| 261 | Example | 2.505 | 3.064 | −0.559 | 80 | 40 | 942 | 125 | 84 |
| 262 | Comparative | 2.934 | 2.932 | 0.002 | 80 | 34 | 1140 | 100 | 100 |
| | example | | | | | | | | |
| 263 | Example | 2.496 | 2.883 | −0.387 | 80 | 45 | 889 | 133 | 78 |
| 264 | Comparative | 2.908 | 2.907 | 0.001 | 80 | 33 | 1139 | 100 | 100 |
| | example | | | | | | | | |
| 265 | Example | 2.465 | 3.014 | −0.549 | 80 | 43 | 820 | 131 | 72 |
| 266 | Comparative | 2.980 | 2.979 | 0.001 | 80 | 34 | 1142 | 100 | 100 |
| | example | | | | | | | | |
| 267 | Example | 2.521 | 3.021 | −0.500 | 80 | 42 | 891 | 123 | 78 |
| 268 | Comparative | 6.027 | 6.027 | 0.000 | 80 | 36 | 782 | 100 | 100 |
| | example | | | | | | | | |
| 269 | Example | 4.841 | 5.407 | −0.566 | 80 | 51 | 547 | 141 | 70 |
| 270 | Comparative | 5.371 | 5.373 | −0.002 | 80 | 40 | 1019 | 100 | 100 |
| | example | | | | | | | | |
| 271 | Example | 4.465 | 4.893 | −0.428 | 80 | 52 | 754 | 129 | 74 |
| 272 | Comparative | 4.346 | 4.346 | 0.000 | 80 | 38 | 861 | 100 | 100 |
| | example | | | | | | | | |
| 273 | Example | 3.499 | 3.976 | −0.477 | 80 | 49 | 637 | 130 | 74 |
| 274 | Comparative | 4.623 | 4.624 | −0.001 | 80 | 39 | 1012 | 100 | 100 |
| | example | | | | | | | | |
| 275 | Example | 4.049 | 4.443 | −0.394 | 80 | 50 | 759 | 127 | 75 |
| 276 | Comparative | 6.530 | 6.532 | −0.002 | 80 | 40 | 791 | 100 | 100 |
| | example | | | | | | | | |
| 277 | Example | 5.493 | 5.934 | −0.441 | 80 | 60 | 657 | 150 | 83 |
| 278 | Comparative | 5.728 | 5.729 | −0.001 | 80 | 38 | 839 | 100 | 100 |
| | example | | | | | | | | |
| 279 | Example | 5.092 | 5.557 | −0.465 | 80 | 55 | 621 | 145 | 74 |
| 280 | Comparative | 4.540 | 4.540 | 0.000 | 80 | 40 | 1084 | 100 | 100 |
| | example | | | | | | | | |
| 281 | Example | 4.007 | 4.586 | −0.579 | 80 | 60 | 878 | 150 | 81 |
| 282 | Comparative | 4.201 | 4.202 | −0.001 | 80 | 39 | 813 | 100 | 100 |
| | example | | | | | | | | |
| 283 | Example | 3.349 | 3.905 | −0.556 | 80 | 48 | 667 | 123 | 82 |
| 284 | Comparative | 6.616 | 6.615 | 0.001 | 80 | 36 | 859 | 100 | 100 |
| | example | | | | | | | | |
| 285 | Example | 5.567 | 6.159 | −0.592 | 80 | 45 | 653 | 126 | 76 |
| 286 | Comparative | 4.190 | 4.190 | 0.000 | 80 | 38 | 916 | 100 | 100 |
| | example | | | | | | | | |
| 287 | Example | 3.547 | 4.091 | −0.544 | 80 | 55 | 714 | 144 | 78 |
| 288 | Comparative | 4.283 | 4.285 | −0.002 | 80 | 40 | 872 | 100 | 100 |
| | example | | | | | | | | |
| 289 | Example | 3.600 | 4.145 | −0.545 | 80 | 58 | 680 | 144 | 78 |
| 290 | Comparative | 5.131 | 5.131 | 0.000 | 80 | 36 | 1094 | 100 | 100 |
| | example | | | | | | | | |
| 291 | Example | 4.072 | 4.664 | −0.592 | 80 | 50 | 788 | 138 | 72 |
| 292 | Comparative | 6.186 | 6.185 | 0.001 | 80 | 36 | 874 | 100 | 100 |
| | example | | | | | | | | |
| 293 | Example | 5.519 | 6.044 | −0.525 | 80 | 44 | 621 | 121 | 71 |
| 294 | Comparative | 6.531 | 6.531 | 0.000 | 80 | 37 | 951 | 100 | 100 |
| | example | | | | | | | | |
| 295 | Example | 5.514 | 5.979 | −0.465 | 80 | 54 | 694 | 146 | 73 |
| 296 | Comparative | 5.445 | 5.444 | 0.001 | 80 | 38 | 1044 | 100 | 100 |
| | example | | | | | | | | |
| 297 | Example | 4.787 | 5.223 | −0.436 | 80 | 55 | 731 | 144 | 70 |
| 298 | Comparative | 5.910 | 5.911 | −0.001 | 80 | 37 | 961 | 100 | 100 |
| | example | | | | | | | | |
| 299 | Example | 4.735 | 5.139 | −0.404 | 80 | 47 | 740 | 128 | 77 |

TABLE 11

| | | | Surface reducing | | |
|---|---|---|---|---|---|
| | | | treatment | | FeCo Concentration in |
| Sam- | Example/ | | Heating | | Soft magnetic particle |
| ple | Comparative | | Temp. | | σ_{FeCo} |
| No. | example | Composition | (° C.) | Atmosphere | (S) |
| 300 | Comparative | Fe_{84.00}B_{4.00}Si_{1.00}Nb_{11.00} | — | — | 6.148 |
| | example | | | | |
| 301 | Example | | 600 | Ar + H₂ (3%) + CH₄ (4%) | 4.956 |
| 302 | Comparative | Fe_{80.00}B_{1.00}P_{9.00}C_{3.00}Nb_{7.00} | — | — | 6.258 |
| | example | | | | |
| 303 | Example | | 600 | Ar + H₂ (3%) + CH₄ (4%) | 5.572 |
| 304 | Comparative | Fe_{75.00}P_{14.00}C_{4.00}Nb_{7.00} | — | — | 4.361 |
| | example | | | | |
| 305 | Example | | 600 | Ar + H₂ (3%) + CH₄ (4%) | 3.214 |
| 306 | Comparative | Fe_{84.00}B_{4.00}Si_{1.00}Zr_{11.00} | — | — | 5.788 |
| | example | | | | |
| 307 | Example | | 600 | Ar + H₂ (3%) + CH₄ (4%) | 5.098 |
| 308 | Comparative | (Fe_{0.80}Co_{0.20})_{80.00}B_{9.00}P_{4.00}Mo_{7.00} | — | — | 4.439 |
| | example | | | | |
| 309 | Example | | 600 | Ar + H₂ (3%) + CH₄ (4%) | 3.666 |
| 310 | Comparative | Fe_{84.00}B_{4.00}Si_{1.00}Mo_{11.00} | — | — | 5.410 |
| | example | | | | |
| 311 | Example | | 600 | Ar + H₂ (3%) + CH₄ (4%) | 4.403 |
| 312 | Comparative | Fe_{73.50}B_{9.00}Si_{13.50}Cu_{1.00}Hf_{3.00} | — | — | 5.464 |
| | example | | | | |
| 313 | Example | | 500 | Ar + H₂ (3%) + CH₄ (4%) | 4.437 |
| 314 | Comparative | (Fe_{0.80}Co_{0.20})_{80.00}B_{9.00}P_{4.00}Hf_{7.00} | — | — | 5.319 |
| | example | | | | |
| 315 | Example | | 600 | Ar + H₂ (3%) + CH₄ (4%) | 4.291 |
| 316 | Comparative | Fe_{84.00}B_{4.00}Si_{1.00}Hf_{11.00} | — | — | 6.566 |
| | example | | | | |
| 317 | Example | | 600 | Ar + H₂ (3%) + CH₄ (4%) | 5.532 |
| 318 | Comparative | Fe_{73.50}B_{9.00}Si_{13.50}Cu_{1.00}Ta_{3.00} | — | — | 5.290 |
| | example | | | | |
| 319 | Example | | 550 | Ar + H₂ (3%) + CH₄ (4%) | 4.750 |
| 320 | Comparative | (Fe_{0.80}Co_{0.20})_{80.00}B_{9.00}P_{4.00}Ta_{7.00} | — | — | 6.169 |
| | example | | | | |
| 321 | Example | | 600 | Ar + H₂ (3%) + CH₄ (4%) | 5.108 |
| 322 | Comparative | Fe_{84.00}B_{4.00}Si_{4.00}Ta_{11.00} | — | — | 6.074 |
| | example | | | | |
| 323 | Example | | 600 | Ar + H₂ (3%) + CH₄ (4%) | 5.509 |
| 324 | Comparative | Fe_{73.50}B_{9.00}Si_{13.5}Cu_{1.00}W_{3.00} | — | — | 6.255 |
| | example | | | | |
| 325 | Example | | 550 | Ar + H₂ (3%) + CH₄ (4%) | 5.122 |
| 326 | Comparative | (Fe_{0.80}Co_{0.20})_{80.00}B_{9.00}P_{4.00}W_{7.00} | — | — | 6.035 |
| | example | | | | |
| 327 | Example | | 600 | Ar + H₂ (3%) + CH₄ (4%) | 5.435 |
| 328 | Comparative | Fe_{84.00}B_{4.00}Si_{1.00}W_{11.00} | — | — | 5.104 |
| | example | | | | |
| 329 | Example | | 600 | Ar + H₂ (3%) + CH₄ (4%) | 4.338 |
| 330 | Comparative | (Fe_{0.75}Co_{0.25})_{79.2}B_{9.50}P_{4.00}Si_{1.00}Nb₆Cu_{0.30} | — | — | 6.772 |
| | example | | | | |
| 331 | Example | | 600 | Ar + H₂ (3%) + CH₄ (4%) | 6.001 |
| 332 | Comparative | (Fe_{0.75}Co_{0.25})_{79.2}B_{9.80}P_{4.00}Si_{1.00}Nb₅Cu₁ | — | — | 5.573 |
| | example | | | | |
| 333 | Example | | 550 | Ar + H₂ (3%) + CH₄ (4%) | 4.556 |
| 334 | Comparative | (Fe_{0.75}Co_{0.25})_{78.5}B_{10.50}P_{4.00}Nb₃Cu₄ | — | — | 4.785 |
| | example | | | | |
| 335 | Example | | 500 | Ar + H₂ (3%) + CH₄ (4%) | 3.882 |
| 336 | Comparative | (Fe_{0.75}Co_{0.25})_{80.95}B_{9.00}P_{3.00}Nb_{7.00}Al_{0.05} | — | — | 5.029 |
| | example | | | | |
| 337 | Example | | 600 | Ar + H₂ (3%) + CH₄ (4%) | 4.058 |
| 338 | Comparative | (Fe_{0.75}Co_{0.25})_{77.00}B_{9.00}P_{3.00}Nb_{7.00}Al_{4.00} | — | — | 5.839 |
| | example | | | | |
| 339 | Example | | 600 | Ar + H₂ (3%) + CH₄ (4%) | 4.900 |
| 340 | Comparative | (Fe_{0.75}Co_{0.25})_{80.00}B_{9.00}P_{3.00}Nb_{7.00}Ti_{1.00} | — | — | 4.093 |
| | example | | | | |
| 341 | Example | | 600 | Ar + H₂ (3%) + CH₄ (4%) | 3.161 |

| | | | | | Magnetic properties | | | |
|---|---|---|---|---|---|---|---|---|
| | | | | Filling | | Pcv | μi | Pcv |
| | | FeCo Concentration in | | rate of | | at | impove- | reduc- |
| Sam- | Example/ | Soft magnetic particle | | mixed | μi | 80% | ment | tion |
| ple | Comparative | | σ_{FeCo} (S) − | powder | at | (kW/ | rate | rate |
| No. | example | σ_{FeCo} (C) | σ_{FeCo} (C) | (%) | 80% | m³) | (%) | (%) |
| 300 | Comparative | 6.147 | 0.001 | 80 | 37 | 817 | 100 | 100 |
| | example | | | | | | | |
| 301 | Example | 5.507 | −0.551 | 80 | 51 | 670 | 138 | 82 |
| 302 | Comparative | 6.256 | 0.002 | 80 | 39 | 952 | 100 | 100 |
| | example | | | | | | | |
| 303 | Example | 6.070 | −0.498 | 80 | 48 | 752 | 124 | 79 |
| 304 | Comparative | 4.359 | 0.002 | 80 | 38 | 819 | 100 | 100 |
| | example | | | | | | | |
| 305 | Example | 3.731 | −0.517 | 80 | 56 | 663 | 148 | 81 |
| 306 | Comparative | 5.786 | 0.002 | 80 | 37 | 816 | 100 | 100 |
| | example | | | | | | | |
| 307 | Example | 5.648 | −0.550 | 80 | 49 | 571 | 132 | 70 |
| 308 | Comparative | 4.438 | 0.001 | 80 | 36 | 868 | 100 | 100 |
| | example | | | | | | | |
| 309 | Example | 4.243 | −0.577 | 80 | 48 | 729 | 133 | 84 |
| 310 | Comparative | 5.409 | 0.001 | 80 | 39 | 860 | 100 | 100 |
| | example | | | | | | | |
| 311 | Example | 5.020 | −0.617 | 80 | 56 | 602 | 143 | 70 |
| 312 | Comparative | 5.463 | 0.001 | 80 | 40 | 981 | 100 | 100 |
| | example | | | | | | | |
| 313 | Example | 4.874 | −0.437 | 80 | 58 | 687 | 145 | 70 |
| 314 | Comparative | 5.320 | −0.001 | 80 | 36 | 1035 | 100 | 100 |
| | example | | | | | | | |
| 315 | Example | 4.761 | −0.470 | 80 | 53 | 859 | 147 | 83 |
| 316 | Comparative | 6.565 | 0.001 | 80 | 38 | 807 | 100 | 100 |
| | example | | | | | | | |
| 317 | Example | 5.996 | −0.464 | 80 | 48 | 638 | 126 | 79 |
| 318 | Comparative | 5.291 | −0.001 | 80 | 36 | 1055 | 100 | 100 |
| | example | | | | | | | |
| 319 | Example | 5.352 | −0.602 | 80 | 46 | 855 | 129 | 81 |
| 320 | Comparative | 6.169 | 0.000 | 80 | 40 | 1016 | 100 | 100 |
| | example | | | | | | | |
| 321 | Example | 5.620 | −0.512 | 80 | 58 | 742 | 146 | 73 |
| 322 | Comparative | 6.076 | −0.002 | 80 | 38 | 914 | 100 | 100 |
| | example | | | | | | | |
| 323 | Example | 5.912 | −0.403 | 80 | 50 | 686 | 131 | 75 |
| 324 | Comparative | 6.256 | −0.001 | 80 | 37 | 918 | 100 | 100 |
| | example | | | | | | | |
| 325 | Example | 5.714 | −0.592 | 80 | 55 | 707 | 149 | 77 |
| 326 | Comparative | 6.033 | 0.002 | 80 | 40 | 1034 | 100 | 100 |
| | example | | | | | | | |
| 327 | Example | 6.063 | −0.628 | 80 | 52 | 755 | 129 | 73 |
| 328 | Comparative | 5.104 | 0.000 | 80 | 39 | 993 | 100 | 100 |
| | example | | | | | | | |
| 329 | Example | 4.904 | −0.566 | 80 | 50 | 695 | 127 | 70 |
| 330 | Comparative | 6.772 | 0.000 | 80 | 40 | 943 | 100 | 100 |
| | example | | | | | | | |
| 331 | Example | 6.408 | −0.407 | 80 | 60 | 707 | 149 | 75 |
| 332 | Comparative | 5.572 | 0.001 | 80 | 38 | 979 | 100 | 100 |
| | example | | | | | | | |
| 333 | Example | 4.960 | −0.404 | 80 | 52 | 744 | 137 | 76 |
| 334 | Comparative | 4.787 | −0.002 | 80 | 38 | 829 | 100 | 100 |
| | example | | | | | | | |
| 335 | Example | 4.288 | −0.406 | 80 | 48 | 705 | 126 | 85 |
| 336 | Comparative | 5.028 | 0.001 | 80 | 40 | 1095 | 100 | 100 |
| | example | | | | | | | |
| 337 | Example | 4.498 | −0.440 | 80 | 54 | 898 | 134 | 82 |
| 338 | Comparative | 5.838 | 0.001 | 80 | 38 | 776 | 100 | 100 |
| | example | | | | | | | |
| 339 | Example | 5.318 | −0.418 | 80 | 55 | 582 | 145 | 75 |
| 340 | Comparative | 4.091 | 0.002 | 80 | 40 | 994 | 100 | 100 |
| | example | | | | | | | |
| 341 | Example | 3.688 | −0.527 | 80 | 58 | 765 | 146 | 77 |

TABLE 12

| | | | Surface reducing treatment | | |
|---|---|---|---|---|---|
| | Example/ | | Heating | | |
| Sample | Comparative | | Temp. | | FeCo Concentration in Soft magnetic particle |
| No. | example | Composition | (° C.) | Atmosphere | σ_{FeCo} (S) |
| 342 | Comparative | (Fe_{0.75}Co_{0.25})_{80.00}B_{9.00}P_{3.00}Nb_{7.00}V_{1.00} | — | — | 5.800 |
| | example | | | | |
| 343 | Example | | 600 | Ar + H₂ (3%) + CH₄ (4%) | 4.763 |
| 344 | Comparative | (Fe_{0.750}Co_{0.25})_{80.00}B_{9.00}P_{3.00}Nb_{7.00}Mn_{1.00} | — | — | 6.674 |
| | example | | | | |
| 345 | Example | | 600 | Ar + H₂ (3%) + CH₄ (4%) | 5.886 |
| 346 | Comparative | (Fe_{0.75}Co_{0.25})_{80.00}B_{9.00}P_{3.00}Nb_{7.00}Zn_{1.00} | — | — | 5.901 |
| | example | | | | |
| 347 | Example | | 600 | Ar + H₂ (3%) + CH₄ (4%) | 5.021 |
| 348 | Comparative | (Fe_{0.75}Co_{0.25})_{80.00}B_{9.00}P_{3.00}Nb_{7.00}Ga_{1.00} | — | — | 6.130 |
| | example | | | | |
| 349 | Example | | 600 | Ar + H₂ (3%) + CH₄ (4%) | 5.046 |
| 350 | Comparative | (Fe_{0.75}Co_{0.25})_{80.00}B_{9.00}P_{3.00}Nb_{7.00}As_{1.00} | — | — | 5.804 |
| | example | | | | |
| 351 | Example | | 600 | Ar + H₂ (3%) + CH₄ (4%) | 4.652 |
| 352 | Comparative | (Fe_{0.75}Co_{0.25})_{80.00}B_{9.00}P_{3.00}Nb_{7.00}Ag_{1.00} | | | 4.786 |
| | example | | | | |
| 353 | Example | | 600 | Ar + H₂ (3%) + CH₄ (4%) | 3.803 |
| 354 | Comparative | (Fe_{0.75}Co_{0.25})_{80.00}B_{9.00}P_{3.00}Nb_{7.00}Sn_{1.00} | — | — | 5.771 |
| | example | | | | |
| 355 | Example | | 600 | Ar + H₂ (3%) + CH₄ (4%) | 4.884 |
| 356 | Comparative | (Fe_{0.75}Co_{0.25})_{80.00}B_{9.00}P_{3.00}Nb_{7.00}Sb_{1.00} | — | — | 5.417 |
| | example | | | | |
| 357 | Example | | 600 | Ar + H₂ (3%) + CH₄ (4%) | 4.791 |
| 358 | Comparative | (Fe_{0.75}Co_{0.25})_{80.00}B_{9.00}P_{3.00}Nb_{7.00}Au_{1.00} | — | — | 5.627 |
| | example | | | | |
| 359 | Example | | 600 | Ar + H₂ (3%) + CH₄ (4%) | 4.876 |
| 360 | Comparative | (Fe_{0.75}Co_{0.25})_{80.00}B_{9.00}P_{3.00}Nb_{7.00}Bi_{1.00} | — | — | 6.635 |
| | example | | | | |
| 361 | Example | | 600 | Ar + H₂ (3%) + CH₄ (4%) | 5.785 |
| 362 | Comparative | (Fe_{0.75}Co_{0.25})_{80.00}B_{9.00}P_{3.00}Nb_{7.00}Y_{1.00} | — | — | 6.090 |
| | example | | | | |
| 363 | Example | | 600 | Ar + H₂ (3%) + CH₄ (4%) | 5.209 |
| 364 | Comparative | (Fe_{0.75}Co_{0.25})_{80.00}B_{9.00}P_{3.00}Nb_{7.00}La_{1.00} | — | — | 6.201 |
| | example | | | | |
| 365 | Example | | 600 | Ar + H₂ (3%) + CH₄ (4%) | 5.632 |
| 366 | Comparative | (Fe_{0.75}Co_{0.25})_{80.00}B_{9.00}P_{3.00}Nb_{7.00}Pt_{1.00} | — | — | 5.119 |
| | example | | | | |
| 367 | Example | | 600 | Ar + H₂ (3%) + CH₄ (4%) | 4.128 |
| 368 | Comparative | (Fe_{0.75}Co_{0.25})_{80.95}B_{9.00}P_{3.00}Nb_{7.00}S_{0.05} | — | — | 4.119 |
| | example | | | | |
| 369 | Example | | 600 | Ar + H₂ (3%) + CH₄ (4%) | 3.268 |
| 370 | Comparative | (Fe_{0.75}Co_{0.25})_{80.00}B_{9.00}P_{3.00}Nb_{7.00}Si_{1.00} | — | — | 4.839 |
| | example | | | | |
| 371 | Example | | 600 | Ar + H₂ (3%) + CH₄ (4%) | 3.662 |
| 372 | Comparative | (Fe_{0.75}Co_{0.25})_{80.90}B_{9.00}P_{3.00}Nb_{7.00}Mg_{0.1}₀ | — | — | 4.603 |
| | example | | | | |
| 373 | Example | | 600 | Ar + H₂ (3%) + CH₄ (4%) | 3.756 |
| 374 | Comparative | (Fe_{0.75}Co_{0.25})_{80.90}B_{9.00}P_{3.00}Nb_{7.00}Ca_{0.10} | — | — | 4.743 |
| | example | | | | |
| 375 | Example | | 600 | Ar + H₂ (3%) + CH₄ (4%) | 3.946 |
| 376 | Comparative | (Fe_{0.75}Co_{0.25})_{80.99}B_{9.00}P_{3.00}Nb_{7.00}N_{0.01} | — | — | 4.599 |
| | example | | | | |
| 377 | Example | | 600 | Ar + H₂ (3%) + CH₄ (4%) | 3.961 |
| 378 | Comparative | (Fe_{0.75}Co_{0.25})_{80.90}B_{9.00}P_{3.00}Nb_{7.00}N_{0.10} | — | — | 4.139 |
| | example | | | | |
| 379 | Example | | 600 | Ar + H₂ (3%) + CH₄ (4%) | 3.268 |
| 380 | Comparative | (Fe_{0.75}Co_{0.25})_{80.90}B_{9.00}P_{3.00}Nb_{7.00}O_{0.10} | — | — | 4.440 |
| | example | | | | |
| 381 | Example | | 600 | Ar + H₂ (3%) + CH₄ (4%) | 3.932 |
| 382 | Comparative | (Fe_{0.75}Co_{0.25})_{78.00}B_{9.00}P_{3.00}Nb_{7.00}O_{3.00} | — | — | 6.269 |
| | example | | | | |
| 383 | Example | | 600 | Ar + H₂ (3%) + CH₄ (4%) | 5.646 |

| | | | | Filling rate | Magnetic properties | | μi | Pcv |
|---|---|---|---|---|---|---|---|---|
| | Example/ | FeCo Concentration in Soft magnetic particle | | of mixed | | Pcv | impovement | reduction |
| Sample | Comparative | | σ_{FeCo} (S) − | powder | μi | at 80% | rate | rate |
| No. | example | σ_{FeCo} (C) | σ_{FeCo} (C) | (%) | at 80% | (kW/m³) | (%) | (%) |
| 342 | Comparative | 5.802 | −0.002 | 80 | 37 | 1020 | 100 | 100 |
| | example | | | | | | | |
| 343 | Example | 5.319 | −0.556 | 80 | 49 | 847 | 133 | 83 |
| 344 | Comparative | 6.675 | −0.001 | 80 | 36 | 1092 | 100 | 100 |
| | example | | | | | | | |
| 345 | Example | 6.368 | −0.482 | 80 | 43 | 863 | 120 | 79 |
| 346 | Comparative | 5.899 | 0.002 | 80 | 40 | 85 | 100 | 100 |
| | example | | | | | | | |
| 347 | Example | 5.628 | −0.607 | 80 | 56 | 706 | 139 | 83 |
| 348 | Comparative | 6.131 | −0.001 | 80 | 36 | 1085 | 100 | 100 |
| | example | | | | | | | |
| 349 | Example | 5.691 | −0.645 | 80 | 51 | 760 | 142 | 70 |
| 350 | Comparative | 5.806 | −0.002 | 80 | 36 | 1005 | 100 | 100 |
| | example | | | | | | | |
| 351 | Example | 5.157 | −0.505 | 80 | 49 | 734 | 136 | 73 |
| 352 | Comparative | 4.786 | 0.000 | 80 | 40 | 906 | 100 | 100 |
| | example | | | | | | | |
| 353 | Example | 4.325 | −0.522 | 80 | 58 | 661 | 144 | 73 |
| 354 | Comparative | 5.769 | 0.002 | 80 | 37 | 1037 | 100 | 100 |
| | example | | | | | | | |
| 355 | Example | 5.440 | −0.556 | 80 | 51 | 881 | 137 | 85 |
| 356 | Comparative | 5.416 | 0.001 | 80 | 36 | 895 | 100 | 100 |
| | example | | | | | | | |
| 357 | Example | 5.159 | −0.368 | 80 | 54 | 689 | 149 | 77 |
| 358 | Comparative | 5.628 | −0.001 | 80 | 38 | 890 | 100 | 100 |
| | example | | | | | | | |
| 359 | Example | 5.517 | −0.641 | 80 | 51 | 685 | 133 | 77 |
| 360 | Comparative | 6.636 | 0.000 | 80 | 38 | 1021 | 100 | 100 |
| | example | | | | | | | |
| 361 | Example | 6.253 | −0.468 | 80 | 46 | 837 | 121 | 82 |
| 362 | Comparative | 6.092 | −0.002 | 80 | 37 | 902 | 100 | 100 |
| | example | | | | | | | |
| 363 | Example | 5.761 | −0.552 | 80 | 54 | 658 | 147 | 73 |
| 364 | Comparative | 6.200 | 0.001 | 80 | 38 | 919 | 100 | 100 |
| | example | | | | | | | |
| 365 | Example | 6.095 | −0.463 | 80 | 52 | 717 | 136 | 78 |
| 366 | Comparative | 5.120 | −0.001 | 80 | 38 | 973 | 100 | 100 |
| | example | | | | | | | |
| 367 | Example | 4.526 | −0.398 | 80 | 55 | 827 | 144 | 85 |
| 368 | Comparative | 4.118 | 0.001 | 80 | 39 | 931 | 100 | 100 |
| | example | | | | | | | |
| 369 | Example | 3.678 | −0.410 | 80 | 49 | 689 | 125 | 74 |
| 370 | Comparative | 4.840 | −0.001 | 80 | 38 | 777 | 100 | 100 |
| | example | | | | | | | |
| 371 | Example | 4.154 | −0.492 | 80 | 52 | 645 | 137 | 83 |
| 372 | Comparative | 4.602 | 0.001 | 80 | 40 | 1048 | 100 | 100 |
| | example | | | | | | | |
| 373 | Example | 4.110 | −0.354 | 80 | 52 | 880 | 130 | 84 |
| 374 | Comparative | 4.742 | 0.001 | 80 | 36 | 970 | 100 | 100 |
| | example | | | | | | | |
| 375 | Example | 4.502 | −0.556 | 80 | 49 | 728 | 136 | 75 |
| 376 | Comparative | 4.601 | −0.002 | 80 | 37 | 842 | 100 | 100 |
| | example | | | | | | | |
| 377 | Example | 4.344 | −0.383 | 80 | 46 | 615 | 123 | 73 |
| 378 | Comparative | 4.137 | 0.002 | 80 | 39 | 1051 | 100 | 100 |
| | example | | | | | | | |
| 379 | Example | 3.680 | −0.412 | 80 | 55 | 830 | 142 | 79 |
| 380 | Comparative | 4.440 | 0.000 | 80 | 38 | 1063 | 100 | 100 |
| | example | | | | | | | |
| 381 | Example | 4.491 | −0.559 | 80 | 52 | 787 | 138 | 74 |
| 382 | Comparative | 6.269 | 0.000 | 80 | 37 | 834 | 100 | 100 |
| | example | | | | | | | |
| 383 | Example | 6.073 | −0.427 | 80 | 46 | 617 | 124 | 74 |

According to Tables 2 to 12, in the case that σ_{FeCo}(S)−σ_{FeCo}(C) was within the above-mentioned range, the μi improvement rate tends to be larger, and the Pcv reduction rate tends to be smaller, thus it was confirmed that a magnetic core having a high permeability and a low loss can be obtained.

### Experiment 3

For each sample of an even number shown in Table 13, the soft magnetic powder was produced by the same method as in the case of Sample Nos. 1a to 1d. A coating part was formed on a soft magnetic particle included in the obtained soft magnetic powder using a mechanofusion device. Regarding Sample Nos. 384, 386, and 388, P—Zn—Al—O-based oxide glass was formed as the coating part. Regarding Sample No. 390, Bi—Zn—B—Si—O-based oxide glass was formed as the coating part. Regarding Sample No. 392, Ba—Zn—B—Si—Al—O-based oxide glass was formed as the coating part. Note that, a thickness of the coating part was controlled by an amount of a coating material added for forming the coating part.

A mixed powder was obtained using the soft magnetic powder including the soft magnetic particle having the coating part, and a toroidal core was produced using the same method as in the case of Sample Nos. 1a to 1d. Magnetic properties of the toroidal core were evaluated using the same method as in the case of Sample Nos. 1a to 1d, thereby μi and Pcv at the filling rates shown in Table 13 were calculated. That is, in Table 13, each sample number consists of four samples, and magnetic properties of these four samples were used to calculate μi and Pcv at the predetermined filling rate of each sample number, which is the same as in the case of Experiment 1. The results are shown in Table 13.

For each sample of an odd number shown in Table 13, the soft magnetic powder was produced by the same method as in the case of Sample Nos. 2a to 2d. A coating part was formed on a soft magnetic particle included in the obtained soft magnetic powder using a mechanofusion device. Regarding each of Sample Nos. 385, 387, and 389, P—Zn—Al—O-based oxide glass was formed as the coating part. Regarding Sample No. 391, Bi—Zn—B—Si—O-based oxide glass was formed as the coating part. Regarding Sample No. 393, Ba—Zn—B—Si—Al—O-based oxide glass was formed as the coating part. Note that, a thickness of the coating part was controlled by an amount of a coating material added for forming the coating part.

A mixed powder was obtained using the soft magnetic powder including the soft magnetic particle having the coating part, and a toroidal core was produced using the same method as in the case of Sample Nos. 2a to 2d. Magnetic properties of the toroidal core were evaluated using the same method as in the case of Sample Nos. 2a to 2d, thereby μi and Pcv at the filling rate shown in Table 13 were calculated. Using the calculated μi and Pcv, a μi improvement rate with respect to μi of the sample number having the same oxide glass composition and the same thickness, and a Pcv reduction rate with respect to Pcv of the same sample number were calculated. For example, the μi improvement rate and the Pcv reduction rate of Sample No. 385 were the relative values when the values of μi and Pcv of Sample No. 384, which had the same oxide glass composition and the thickness, were considered 100%. The results are shown in Table 13.

TABLE 13

| | | | | Surface reducing treatment | | |
|---|---|---|---|---|---|---|
| Sam- | Example/ | Coating part | | Heating | | |
| ple | Comparative | | Thickness | Temp. | | FeCo Concentration in Soft magnetic particle |
| No. | example | Material | (nm) | (° C.) | Atmosphere | σ_{FeCo} (S) |
| 1 | Comparative | — | — | — | — | 1.878 |
| | example | | | | | |
| 2 | Example | | | 900 | Ar + H₂ (3%) + CH₄ (4%) | 1.443 |
| 384 | Comparative | P—Zn—Na—Al—O | 20 | — | — | 1.878 |
| | example | | | | | |
| 385 | Example | | | 900 | Ar + H₂ (3%) + CH₄ (4%) | 1.443 |
| 386 | Comparative | P—Zn—Na—Al—O | 100 | — | — | 1.878 |
| | example | | | | | |
| 387 | Example | | | 900 | Ar + H₂ (3%) + CH₄ (4%) | 1.443 |
| 388 | Comparative | P—Zn—Na—Al—O | 250 | — | — | 1.878 |
| | example | | | | | |
| 389 | Example | | | 900 | Ar + H₂ (3%) + CH₄ (4%) | 1.443 |
| 390 | Comparative | Bi—Zn—B—Si—O | 20 | — | — | 1.878 |
| | example | | | | | |
| 391 | Example | | | 900 | Ar + H₂ (3%) + CH₄ (4%) | 1.443 |
| 392 | Comparative | Ba—Zn—B—Si—Al—O | 20 | — | — | 1.878 |
| | example | | | | | |
| 393 | Example | | | 900 | Ar + H₂ (3%) + CH₄ (4%) | 1.443 |

| | | | | Filling | Magnetic properties | | μi | Pcv |
|---|---|---|---|---|---|---|---|---|
| | | | | rate of | | Pcv | impove- | reduc- |
| Sam- | Example/ | FeCo Concentration in Soft magnetic particle | | mixed | | at 80% | ment | tion |
| ple | Comparative | | σ_{FeCo} (S) − | powder | μi | (kW/ | rate | rate |
| No. | example | σ_{FeCo} (C) | σ_{FeCo} (C) | (%) | at 80% | m³) | (%) | (%) |
| 1 | Comparative | 1.880 | −0.002 | 80 | 29 | 1677 | 100 | 100 |
| | example | | | | | | | |
| 2 | Example | 1.847 | −0.404 | 80 | 43 | 1177 | 148 | 70 |
| 384 | Comparative | 1.880 | −0.002 | 81 | 26 | 1587 | 100 | 100 |
| | example | | | | | | | |
| 385 | Example | 1.847 | −0.404 | 81 | 39 | 1178 | 148 | 74 |
| 386 | Comparative | 1.880 | −0.002 | 79 | 24 | 1563 | 100 | 100 |
| | example | | | | | | | |
| 387 | Example | 1.847 | −0.404 | 79 | 36 | 1121 | 148 | 72 |
| 388 | Comparative | 1.880 | −0.002 | 79 | 23 | 1558 | 100 | 100 |
| | example | | | | | | | |
| 389 | Example | 1.847 | −0.404 | 79 | 33 | 1197 | 143 | 77 |
| 390 | Comparative | 1.880 | −0.002 | 80 | 28 | 1568 | 100 | 100 |
| | example | | | | | | | |
| 391 | Example | 1.847 | −0.404 | 80 | 40 | 1145 | 143 | 73 |
| 392 | Comparative | 1.880 | −0.002 | 80 | 27 | 1578 | 100 | 100 |
| | example | | | | | | | |
| 393 | Example | 1.847 | −0.404 | 80 | 39 | 1152 | 143 | 73 |

According to Table 13, regarding the soft magnetic particle having the coating part on the surface, as long as σ_{FeCo}(S)−σ_{FeCo}(C) was within the above-mentioned range, the μi improvement rate tends to be larger, and the Pcv reduction rate tends to be smaller, thus it was confirmed that a magnetic core having a high permeability and a low loss can be obtained.

### Experiment 4

For each sample of an even number shown in Table 14, the soft magnetic powder was produced using the same method as in the case of Sample Nos. 1a to 1d, and the obtained soft magnetic powder (large size powder) and pure iron powder (small size powder) were mixed in a ratio shown in Table 14, thereby a mixed powder was obtained. Using the mixed powder, a toroidal core was produced using the same method as in the case of Sample Nos. 1a to 1d. Magnetic properties of the toroidal core were evaluated using the same method as in the case of Sample Nos. 1a to 1d, thereby μi and Pcv at the filling rates shown in Table 14 were calculated. That is, in Table 14, each sample number consists of four samples, and magnetic properties of these four samples were used to calculate μi and Pcv at the predetermined filling rate of each sample number, which is the same as in the case of Experiment 1. The results are shown in Table 14.

For each sample of an odd number shown in Table 14, the mixed powder was produced using the same method as in the case of Sample Nos. 2a to 2d except that the soft magnetic powder (large size powders) and the pure iron powder (small size powder) were mixed in a ratio shown in Table 14, thereby a mixed powder was obtained. The obtained mixed powder was used to produce a toroidal core using the same method as in the case of Sample Nos. 2a to 2d. Magnetic properties of the toroidal core were evaluated by the same method as in the case of Sample Nos. 2a to 2d, thereby μi and Pcv at the filling rate shown in Table 14 were calculated. Using the calculated μi and Pcv, a μi improvement rate with respect to μi of the sample number having the same mixing ratio of the large size powder and the small size powder, and a Pcv reduction rate with respect to Pcv of the same sample number were calculated. For example, the μi improvement rate and the Pcv reduction rate of Sample No. 395 were the relative values when the values of μi and Pcv of Sample No. 394, which had the same mixing ratio of the large size powder and the small size powder, were considered 100%. The results are shown in Table 14.

TABLE 14

| | | | | Surface reducing treatment | | |
|---|---|---|---|---|---|---|
| | Example/ | Blending ratio (mass %) | | Heating | | |
| Sample | Comparative | Large size | Small size | Temp | | FeCo Concentration in Soft magnetic particle |
| No. | example | powder | powder | (° C.) | Atmosphere | σ_{FeCo} (S) |
| 1 | Comparative | 80 | 20 | — | — | 1.878 |
| | example | | | | | |
| 2 | Example | | | 900 | Ar + H₂ (3%) + CH₄ (4%) | 1.443 |
| 394 | Comparative | 100 | 0 | — | — | 1.878 |
| | example | | | | | |
| 395 | Example | | | 900 | Ar + H₂ (3%) + CH₄ (4%) | 1.443 |
| 396 | Comparative | 60 | 40 | — | — | 1.878 |
| | example | | | | | |
| 397 | Example | | | 900 | Ar + H₂ (3%) + CH₄ (4%) | 1.443 |
| 398 | Comparative | 40 | 60 | — | — | 1.878 |
| | example | | | | | |
| 399 | Example | | | 900 | Ar + H₂ (3%) + CH₄ (4%) | 1.443 |
| 400 | Comparative | 30 | 70 | — | — | 1.878 |
| | example | | | | | |
| 401 | Example | — | — | 900 | Ar + H₂ (3%) + CH₄ (4%) | 1.443 |

| | | | | Filling rate | Magnetic properties | | μi | Pcv |
|---|---|---|---|---|---|---|---|---|
| | Example/ | FeCo Concentration in Soft magnetic particle | | of mixed | | Pcv | impovement | reduction |
| Sample | Comparative | | σ_{FeCo} (S) − | powder | μi | at 80% | rate | rate |
| No. | example | σ_{FeCo} (C) | σ_{FeCo} (C) | (%) | at 80% | (kW/m³) | (%) | (%) |
| 1 | Comparative | 1.880 | −0.002 | 80 | 29 | 1677 | 100 | 100 |
| | example | | | | | | | |
| 2 | Example | 1.847 | −0.404 | 80 | 43 | 1177 | 148 | 70 |
| 394 | Comparative | 1.880 | −0.002 | 79 | 24 | 1717 | 100 | 100 |
| | example | | | | | | | |
| 395 | Example | 1.847 | −0.404 | 79 | 37 | 1172 | 154 | 68 |
| 396 | Comparative | 1.880 | −0.002 | 77 | 26 | 1611 | 100 | 100 |
| | example | | | | | | | |
| 397 | Example | 1.847 | −0.404 | 77 | 34 | 1276 | 131 | 79 |
| 398 | Comparative | 1.880 | −0.002 | 75 | 24 | 1579 | 100 | 100 |
| | example | | | | | | | |
| 399 | Example | 1.847 | −0.404 | 75 | 29 | 1389 | 121 | |
| 400 | Comparative | 1.880 | −0.002 | 73 | 23 | 1545 | 100 | 100 |
| | example | | | | | | | |
| 401 | Example | 1.847 | −0.404 | 73 | 26 | 1400 | 113 | 91 |

According to Table 14, even when the mixing ratio of the soft magnetic powder including the above-mentioned soft magnetic particles were changed, as long as σ_{FeCo}(S)−σ_{FeCo}(C) was within the above-mentioned range, the μi improvement rate tends to be larger, and the Pcv reduction rate tends to be smaller, thus it was confirmed that a magnetic core having a high permeability and a low loss can be obtained.

### Experiment 5

For each sample of an even number shown in Table 15, the soft magnetic powder was produced using the same method as in the case of Sample Nos. 1a to 1d except that an average particle size was 3 μm using a classification treatment. A Fe—Co—B—P—Si—Cr-based alloy powder having an amorphous structure was used as the large size powder, the obtained soft magnetic powder was used as an intermediate size powder, and a pure iron powder used in Experiment 1 was used as a small size powder. An average particle size of the large size powder was 20 μm.

The large size powder, the intermediate size powder, and the small size powder were mixed in a ratio shown in Table 15, thereby a mixed powder was obtained. Using the mixed powder, a toroidal core was produced using the same method as in the case of Sample Nos. 1a to 1d. Magnetic properties of the toroidal core were evaluated using the same method as in the case of Sample Nos. 1a to 1d, thereby μi and Pcv at the filling rates shown in Table 15 were calculated. That is, in Table 15, each sample number consists of four samples, and magnetic properties of these four samples were used to calculate μi and Pcv at the predetermined filling rate of each sample number, which is the same as in the case of Experiment 1. The results are shown in Table 15.

For each sample of an odd number shown in Table 15, the soft magnetic powder was produced using the same method as in the case of Sample Nos. 2a to 2d except that an average particle size was 3 μm using a classification treatment. A Fe—Co—B—P—Si—Cr-based alloy powder having an amorphous structure was used as the large size powder, the obtained soft magnetic powder was used as an intermediate size powder, and the pure iron powder used in Experiment 1 was used as a small size powder. An average particle size of the large size powder was 20 μm.

The large size powder, the intermediate size powder, and the small size powder were mixed in a ratio shown in Table 15, thereby a mixed powder was obtained. Using the mixed powder, a toroidal core was produced using the same method as in the case of Sample Nos. 2a to 2d. Magnetic properties of the toroidal core were evaluated using the same method as in the case of Sample Nos. 2a to 2d, thereby μi and Pcv at the filling rates shown in Table 15 were calculated. Using the calculated μi and Pcv, a μi improvement rate with respect to μi of the sample number having the same mixing ratio of the large size powder, the intermediate size powder, and the small size powder, and a Pcv reduction rate with respect to Pcv of the same sample number were calculated. For example, the μi improvement rate and the Pcv reduction rate of Sample No. 403 were the relative values when the values of μi and Pcv of Sample No. 402, which had the same mixing ratio of the large size powder, the intermediate size powder, and the small size powder, was considered 100%. The results are shown in Table 15.

TABLE 15

| | | Blending ratio (mass %) | | | | | |
|---|---|---|---|---|---|---|---|
| | | | inter- | | Surface reducing treatment | | |
| | Example/ | Large | mediate | Small | Heating | | |
| Sample | Comparative | size | size | size | Temp. | | FeCo Concentration in Soft magnetic particle |
| No. | example | powder | powder | powder | (° C.) | Atmosphere | σ_{FeCo} (S) |
| 402 | Comparative | 60 | 30 | 10 | — | — | 1.849 |
| | example | | | | | | |
| 403 | Example | | | | 900 | Ar + H₂ (3%) + CH₄ (4%) | 1.558 |
| 404 | Comparative | 50 | 40 | 10 | — | — | 1.849 |
| | example | | | | | | |
| 405 | Example | | | | 900 | Ar + H₂ (3%) + CH₄ (4%) | 1.558 |
| 406 | Comparative | 20 | 70 | 10 | — | — | 1.849 |
| | example | | | | | | |
| 407 | Example | — | — | — | 900 | Ar + H₂ (3%) + CH₄ (4%) | 1.558 |

| | | | | Filling | | | | |
|---|---|---|---|---|---|---|---|---|
| | | | | rate of | Magnetic properties | | μi | Pcv |
| | Example/ | FeCo Concentration in Soft magnetic particle | | mixed | | Pcv | impovement | reduction |
| Sample | Comparative | | σ_{FeCo} (S) − | powder | μi | at 80% | rate | rate |
| No. | example | σ_{FeCo} (C) | σ_{FeCo} (C) | (%) | at 80% | (kW/m³) | (%) | (%) |
| 402 | Comparative | 1.850 | −0.001 | 80 | 26 | 1602 | 100 | 100 |
| | example | | | | | | | |
| 403 | Example | 1.861 | −0.303 | 80 | 29 | 1459 | 112 | 91 |
| 404 | Comparative | 1.850 | −0.001 | 79 | 26 | 1578 | 100 | 100 |
| | example | | | | | | | |
| 405 | Example | 1.861 | −0.303 | 79 | 31 | 1378 | 119 | 87 |
| 406 | Comparative | 1.850 | −0.001 | 77 | 24 | 1555 | 100 | 100 |
| | example | | | | | | | |
| 407 | Example | 1.861 | −0.303 | 77 | 33 | 1255 | 138 | 81 |

According to Table 15, in the case that the soft magnetic powder including the above-mentioned soft magnetic particle was used as the intermediate size powder, and that the mixing ratio thereof was changed, as long as σ_{FeCo}(S)−σ_{FeCo}(C) was within the above-mentioned range, the μi improvement rate tends to be larger, and the Pcv reduction rate tends to be smaller, thus it was confirmed that a magnetic core having a high permeability and a low loss can be obtained.

### Experiment 6

For each sample of an even number shown in Table 16, the soft magnetic powder was produced using the same method as in the case of Sample Nos. 1a to 1d except that an average particle size was adjusted to the size shown in Table 16 using a classification treatment. Using only the produced soft magnetic powder, a toroidal core was produced using the same method as in the case of Sample Nos. 1a to 1d. Magnetic properties of the toroidal core were evaluated using the same method as in the case of Sample Nos. 1a to 1d, thereby μi and Pcv at the filling rate shown in Table 16 were calculated. That is, in Table 16, each sample number consists of four samples, and magnetic properties of these four samples were used to calculate μi and Pcv at the predetermined filling rate of each sample number, which is the same as in the case of Experiment 1. The results are shown in Table 16.

For each sample of an odd number shown in Table 16, the soft magnetic powder was produced using the same method as in the case of Sample Nos. 2a to 2d except that an average particle size was adjusted to the size shown in Table 16 using a classification treatment. Using only the produced soft magnetic powder, a toroidal core was produced using the same method as in the case of Sample Nos. 2a to 2d. Magnetic properties of the toroidal core were evaluated using the same method as in the case of Sample Nos. 2a to 2d, thereby μi and Pcv at the filling rate shown in Table 16 were calculated. Using the calculated μi and Pcv, a μi improvement rate with respect to μi of the sample number having the same average particle size, and a Pcv reduction rate with respect to Pcv of the same sample number were calculated. For example, the μi improvement rate and the Pcv reduction rate of Sample No. 411 were the relative values when the values of μi and Pcv of Sample No. 410, which had the same average particle size, was considered 100%. The results are shown in Table 16.

TABLE 16

| | | Average | Surface reducing treatment | | | | |
|---|---|---|---|---|---|---|---|
| | Example/ | particle | Heating | | FeCo Concentration in Soft magnetic particle | | |
| Sample | Comparative | size | Temp. | | | | σ_{FeCo} (S) − |
| No. | example | (μm) | (° C.) | Atmosphere | σ_{FeCo} (S) | σ_{FeCo} (C) | σ_{FeCo} (C) |
| 408 | Comparative | 20 | — | — | 1.878 | 1.880 | −0.002 |
| | example | | | | | | |
| 409 | Example | | 900 | Ar + H₂ (3%) + CH₄ (4%) | 1.443 | 1.847 | −0.404 |
| 410 | Comparative | 3 | — | — | 1.849 | 1.850 | −0.001 |
| | example | | | | | | |
| 411 | Example | | 900 | Ar + H₂ (3%) + CH₄ (4%) | 1.558 | 1.861 | −0.303 |
| 412 | Comparative | 5 | — | — | 1.851 | 1.850 | 0.001 |
| | example | | | | | | |
| 413 | Example | | 900 | Ar + H₂ (3%) + CH₄ (4%) | 1.388 | 1.767 | −0.379 |
| 414 | Comparative | 30 | — | — | 1.877 | 1.879 | −0.002 |
| | example | | | | | | |
| 415 | Example | | 900 | Ar + H₂ (3%) + CH₄ (4%) | 1.298 | 1.727 | −0.429 |
| 416 | Comparative | 50 | — | — | 1.877 | 1.878 | −0.001 |
| | example | | | | | | |
| 417 | Example | | 900 | Ar + H₂ (3%) + CH₄ (4%) | 1.286 | 1.702 | −0.416 |

| | | Filling | | | | |
|---|---|---|---|---|---|---|
| | | rate | Magnetic properties | | μi | Pcv |
| | Example/ | of mixed | | Pcv | impovement | reduction |
| Sample | Comparative | powder | μi | at 80% | rate | rate |
| No. | example | (%) | at 80% | (kW/m³) | (%) | (%) |
| 408 | Comparative | 79 | 24 | 1717 | 100 | 100 |
| | example | | | | | |
| 409 | Example | 79 | 37 | 1172 | 154 | 68 |
| 410 | Comparative | 75 | 15 | 1520 | 100 | 100 |
| | example | | | | | |
| 411 | Example | 75 | 22 | 1160 | 147 | 76 |
| 412 | Comparative | 76 | 16 | 1599 | 100 | 100 |
| | example | | | | | |
| 413 | Example | 76 | 24 | 1210 | 150 | 76 |
| 414 | Comparative | 78 | 25 | 1767 | 100 | 100 |
| | example | | | | | |
| 415 | Example | 78 | 37 | 1272 | 148 | 72 |
| 416 | Comparative | 78 | 28 | 1820 | 100 | 100 |
| | example | | | | | |
| 417 | Example | 78 | 42 | 1291 | 150 | 71 |

According to Table 16, in the case that the average particle size was changed while only using the soft magnetic powder which included the above-mentioned soft magnetic particle, as long as σ_{FeCo}(S)−σ_{FeCo}(C) was within the above-mentioned range, the μi improvement rate tends to be larger, and the Pcv reduction rate tends to be smaller, thus it was confirmed that a magnetic core having a high permeability and a low loss can be obtained.

### REFERENCE SIGNS LISTS

1 . . . . Soft magnetic powder
   2 . . . . Soft magnetic particle
   3 . . . . Coating part
10 . . . . Magnetic core
   21 . . . . Large size particle
   22 . . . . Small size particle
   5 . . . . Resin

What is claimed is:

1. A soft magnetic powder comprising a soft magnetic particle containing at least one selected from the group consisting of iron and cobalt:
provided that the soft magnetic particle satisfies the relation of σ_{FeCo}(S)−σ_{FeCo}(C)≤−0.005, when an element distribution obtained by analyzing a surface part of the soft magnetic particle using a 3D atom probe method is divided into a plurality of grids to calculate a sum of a content ratio of iron and a content ratio of cobalt in each grid, and a standard deviation of the sum of the content ratio of iron and the content ratio of cobalt is represented by σ_{FeCo}(S) where a population is the plurality of grids, and
an element distribution obtained by analyzing a center part of the soft magnetic particle using a 3D atom probe method is divided into a plurality of grids to calculate a sum of a content ratio of iron and a content ratio of cobalt in each grid, and a standard deviation of the sum of the content ratio of iron and the content ratio of cobalt is represented by σ_{FeCo}(C) where a population is the plurality of grids.

2. A magnetic core comprising the soft magnetic powder according to claim 1.

3. A magnetic device comprising the magnetic core according to claim 2.
